(19) United States
(12) Patent Application Publication
(10) Pub. No.: US 2026/0312519 A1
(43) Pub. Date: Oct. 8, 2026

(54) ROTARY ELECTRIC MACHINE CONTROL DEVICE, ELECTRIC POWER STEERING DEVICE, AND VEHICLE

(71) Applicant: MITSUBISHI ELECTRIC MOBILITY CORPORATION, Tokyo (JP)

(72) Inventors: Tomohiro TAMARU, Tokyo (JP); Shingo HARADA, Tokyo (JP); Tatsuya MORI, Tokyo (JP); Issei TAKEUCHI, Tokyo (JP); Chiaki FUJIMOTO, Tokyo (JP); Masaki MATSUSHITA, Tokyo (JP)

(73) Assignee: MITSUBISHI ELECTRIC MOBILITY CORPORATION, Tokyo (JP)

(21) Appl. No.: 19/481,755

(22) PCT Filed: Jun. 20, 2023
(86) PCT No.: PCT/JP2023/022686

§ 371 Date: Nov. 5, 2025

(51) Int. Cl. H02P 21/18; B62D 5/04; H02P 21/16; H02P 21/22; H02P 27/08

(52) U.S. Cl. CPC H02P 21/18; B62D 5/0463; H02P 21/16; H02P 21/22; H02P 27/08

(57) ABSTRACT

A rotary electric machine control device according to the present disclosure includes a control angle calculation unit configured to calculate a control rotational angle of a rotor, in which the control angle calculation unit uses a value obtained by integrating a detection angle deviation when a control rotation speed is calculated, or corrects an estimated actual angle deviation based on a rotational angle detection value.

### TECHNICAL FIELD

The present disclosure relates to a rotary electric machine control device, an electric power steering device, and a vehicle.

### BACKGROUND ART

In the related art, a synchronous rotary machine (also referred to as a brushless motor) in which a permanent magnet is provided in a rotor has been used as a rotary electric machine for variable-speed driving. It is common to detect a rotational angle of a rotor to control the rotary electric machine. The rotational angle detected by the rotation sensor includes an error (referred to as a sensor angle error) with respect to a true rotational angle. A direct current component of the sensor angle error is an error of a direct current component of a torque. An alternating current component of the sensor angle error is an error (torque ripple) of an alternating current component of the torque. The torque ripple causes noise from the rotary electric machine. Therefore, in order to have the rotary electric machine rotate quietly, it is important to reduce the alternating current component of the sensor angle error.

Patent Document 1 discloses a technology for reducing the influence of the alternating current component of the sensor angle error. Specifically, the rotary electric machine control device of Patent Document 1 includes a control angle calculation unit. The control angle calculation unit estimates an estimated actual angle deviation, which is a deviation of a control rotational angle with respect to a true rotational angle of a rotor. In addition, a detection angle deviation, which is a deviation of the control rotational angle with respect to the detection value of the rotational angle, is calculated. In addition, a value obtained by internally dividing the estimated actual angle deviation and the detection angle deviation is calculated as a control angle deviation. The control rotational angle is calculated by performing a feedback control such that the control angle deviation approaches 0.

Patent Document 2 discloses a technology for accurately calculating a position of a rotor. For example, in paragraph 0041 of Patent Document 2, there is a description that a d axis voltage and a q axis voltage are calculated when the rotary electric machine adopts inertial braking, which enables a Hall sensor offset angle to be calculated.

### CITATION LIST

### Patent Documents

Patent Document 1: Japanese Patent No. 6818929
Patent Document 2: Japanese Unexamined Patent Application, First Publication No. 2019-103382

### SUMMARY OF INVENTION

### Problem to be Solved by the Invention

The technology of Patent Document 1 has a problem in that the direct current component of the sensor angle error remains when an “electrical constant preset in the control angle calculation unit” does not match an “actual electrical constant of the rotary electric machine”. As described above, the direct current component of the sensor angle error is an error of the direct current component of the torque. The error of the “direct current component of torque” causes a problem where the torques (output) which are outputted differ depending on the rotation direction of the rotary electric machine. For example, when the rotary electric machine is used to assist the electric power steering, there is a difference in the output torque between a case where the steering wheel is steered to the left direction and a case where the steering wheel is steered to the right direction. As a result, there is a problem in that the steering feel felt by the driver differs due to the difference in the rotation direction of the steering wheel.

In addition, it is not possible to realize the technology of Patent Document 2 unless “inertial braking” is adopted. In other words, it is not possible to cope with a case where a current is passed through the rotary electric machine. The influence of the case where the “electrical constant preset in the control angle calculation unit” does not match the “actual electrical constant of the rotary electric machine” is generated when a current is passed through the motor. Therefore, it is difficult to solve the problem of the technology of Patent Document 1 by the disclosure of Patent Document 2.

In view of the above circumstances, an object of the present disclosure is to provide a rotary electric machine control device, an electric power steering device, and a vehicle capable of reducing a direct current component of a sensor angle error.

### Means to Solve the Problem

An aspect of a rotary electric machine control device according to the present disclosure is a rotary electric machine control device configured to control a rotary electric machine including a stator provided with windings of a plurality of phases and a rotor provided with a magnet, via a power converter, the rotary electric machine control device including a rotation detection unit configured to detect a rotational angle of the rotor based on an output signal of a rotation sensor, a control angle calculation unit configured to calculate a control rotational angle of the rotor, a current detection unit configured to detect a current flowing through the windings of the plurality of phases based on an output signal of a current sensor, a voltage command value calculation unit configured to calculate a voltage command value to be applied to the windings of the plurality of phases based on the control rotational angle and a current detection value, and a switching control unit configured to switch on and off a plurality of switching elements included in the power converter based on the voltage command value The control angle calculation unit is configured to calculate an estimated actual angle deviation that is a deviation of the control rotational angle with respect to a true rotational angle of the rotor, based on information on the current detection value, information on the voltage command value, and an electrical constant of the rotary electric machine, calculate a detection angle deviation that is a deviation of the control rotational angle with respect to a rotational angle detection value, calculate a value obtained by internally dividing the estimated actual angle deviation and the detection angle deviation as a control angle deviation, calculate a control rotation speed based on the control angle deviation, calculate the control rotational angle by integrating the control rotation speed, and use a value obtained by integrating the detection angle deviation when the control rotation speed is calculated, or correct the estimated actual angle deviation based on the rotational angle detection value.

An electric power steering device according to the present disclosure includes the control device and the rotary electric machine controlled by the control device.

A vehicle according to the present disclosure includes the electric power steering device.

### Effects of the Invention

According to the rotary electric machine control device, the electric power steering device, and the vehicle according to the present disclosure, it is possible to reduce the direct current component of the sensor angle error.

### BRIEF DESCRIPTION OF DRAWINGS

FIG. 1 A diagram that explains a schematic configuration of an electric power steering device and a vehicle, which include a rotary electric machine control device according to a first embodiment.

FIG. 2 A functional block diagram showing an example configuration of the control device of FIG. 1.

FIG. 3 A diagram showing an example of a hardware configuration of the control device of FIG. 1.

FIG. 4 A diagram explaining an execution region of control according to the first embodiment.

FIG. 5 A diagram explaining an execution region of control according to the first embodiment.

FIG. 6 A functional block diagram showing an example configuration of a control angle calculation unit of FIG. 2.

FIG. 7 A diagram explaining a setting example of internal division ratios Ke and Kd according to the first embodiment.

FIG. 8 A functional block diagram showing an example configuration of a feedback controller of FIG. 6.

FIG. 9 A diagram explaining a problem with the related art.

FIG. 10 A diagram explaining an effect obtained by the first embodiment.

FIG. 11 A diagram showing a gain characteristic of a feedback controller according to the first embodiment.

FIG. 12 A diagram showing a relationship between a variation ratio related to an inductance value and a detection angle deviation.

FIG. 13 A diagram showing a relationship between a variation ratio related to a resistance value and a detection angle deviation.

FIG. 14 A functional block diagram showing an example configuration of a feedback controller according to a second embodiment.

FIG. 15 A diagram explaining an effect obtained by the second embodiment.

FIG. 16 A functional block diagram showing an example configuration of a feedback controller according to a third embodiment.

FIG. 17 A diagram showing a relationship between a detection angle deviation and an inductance correction magnification in the third embodiment.

FIG. 18 A diagram showing a relationship between a detection angle deviation and a resistance correction magnification in a fourth embodiment.

FIG. 19 A functional block diagram showing an example configuration of a control device according to a fifth embodiment.

FIG. 20 A functional block diagram showing an example configuration of a control angle calculation unit according to the fifth embodiment.

FIG. 21 A functional block diagram showing an example configuration of a control device according to a sixth embodiment.

FIG. 22 A functional block diagram showing an example configuration of a control angle calculation unit according to the sixth embodiment.

### DESCRIPTION OF EMBODIMENTS

Hereinafter, embodiments of the present disclosure are described with reference to the drawings. The scope of the present disclosure is not limited to the following embodiment, and may be changed so long as said changes are within the technical scope of the present disclosure.

### First Embodiment

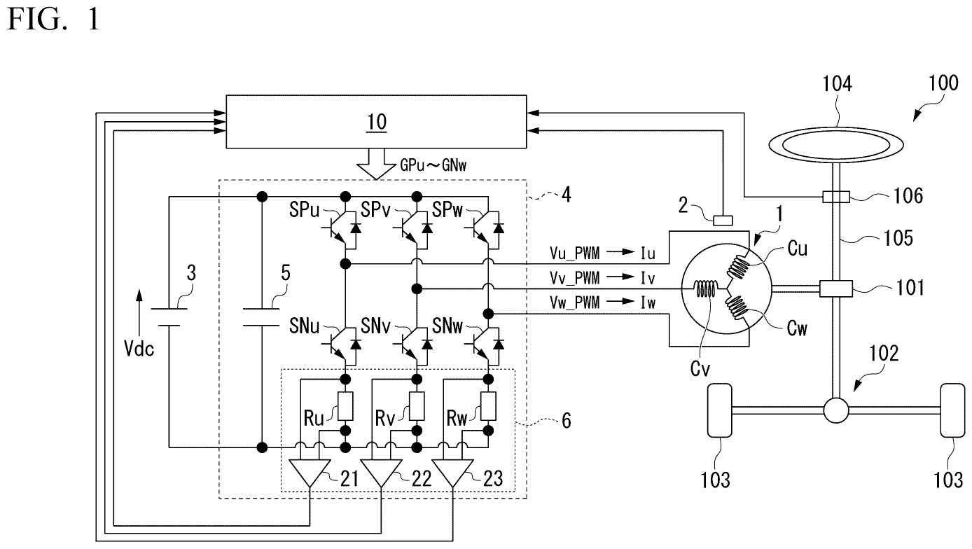

FIG. 1 is a schematic view showing an electric power steering device 100 according to the present embodiment. The electric power steering device 100 includes a rotary electric machine 1, a power converter 4, and a rotary electric machine control device (hereinafter, simply referred to as a control device 10). The electric power steering device 100 is mounted on a vehicle. The rotary electric machine 1 is a driving source of the electric power steering device 100. In addition to the electric power steering device 100, a direct current power supply 3 or the like is mounted on the vehicle.

### (Rotary Electric Machine 1)

The rotary electric machine 1 includes a stator and a rotor disposed radially inside the stator. The stator is provided with windings of a plurality of phases. In the example of FIG. 1, windings Cu, Cv, and Cw of three phases (U phase, V phase, and W phase) are provided in the stator. A magnet is provided in the rotor. In the present embodiment, the magnet is a permanent magnet. In other words, the rotary electric machine 1 is a permanent magnet type synchronous rotary electric machine. The magnet may be an electromagnet having a field winding. The three-phase windings Cu, Cv, and Cw may be star-connected or delta-connected.

A rotation sensor 2 to detect a rotational angle of the rotor is disposed in the vicinity of the rotor of the rotary electric machine 1. As the rotation sensor 2, a resolver, an encoder, an MR sensor, or the like is used. An output signal of the rotation sensor 2 is input to the control device 10.

### (Power Converter 4)

The power converter 4 of the present embodiment is an inverter. The power converter 4 is not limited to an inverter, and for example, a matrix converter may be used. The power converter 4 is configured to convert direct current power of the direct current power supply 3 into alternating current power. The power converter 4 includes three series circuits (legs) each corresponding to three phases, a smoothing capacitor 5, and a current sensor 6. Each of the three legs has a positive electrode-side switching element SP and a negative electrode-side switching element SN.

In FIG. 1, the three positive electrode-side switching elements SP are associated with the U phase, the V phase, and the W phase, and are denoted by SPu, SPv, and SPw. Similarly, the three negative electrode-side switching elements SN are denoted by SNu, SNv, and SNw. Hereinafter, the positive electrode-side switching elements SPu, SPv, and SPw of the three phases may be simply referred to as a “positive electrode-side switching element SP”. Similarly, the negative electrode-side switching elements SNu, SNv, and SNw of the three phases may be simply referred to as a “negative electrode-side switching element SN”.

In each leg, the positive electrode-side switching element SP and the negative electrode-side switching element SN are connected in series. The positive electrode-side switching element SP is connected to a positive electrode of the direct current power supply 3. The negative electrode-side switching element SN is connected to the negative electrode of the direct current power supply 3. In addition, in each leg, the connection point of the two switching elements SP and SN is connected to the winding of the corresponding phase.

Specifically, in the leg of the U phase, the positive electrode-side switching element SPu and the negative electrode-side switching element SNu are connected in series. The connection point of the two switching elements SPu and SNu is connected to the winding Cu of the U phase. In the leg of the V phase, the positive electrode-side switching element SPv and the negative electrode-side switching element SNv are connected in series. The connection point of the two switching elements SPv and SNv is connected to the winding Cv of the V phase. In the leg of the W phase, the positive electrode-side switching element SPw and the negative electrode-side switching element SNw are connected in series. The connection point of the two switching elements SPw and SNw is connected to the winding Cw of the W phase. The smoothing capacitor 5 is connected to a positive electrode and a negative electrode of the direct current power supply 3. The smoothing capacitor 5 is connected in parallel with the legs of the three phases.

As the switching elements SP and SN, an insulated gate bipolar transistor (IGBT) in which diodes are connected in reverse parallel, a metal oxide semiconductor field effect transistor (MOSFET), a bipolar transistor in which diodes are connected in reverse parallel, or the like may be employed. A gate terminal of each of the switching elements SP and SN is connected to the control device 10 via a gate drive circuit or the like. Each of the switching elements SP and SN is switched to ON/OFF based on switching signals GPu to GNw output from the control device 10.

The direct current power supply 3 outputs a direct current voltage Vdc to the power converter 4. In the present embodiment, the direct current voltage Vdc is 12 [V]. As the direct current power supply 3, any device capable of outputting the direct current voltage Vdc may be employed. As the direct current power supply 3, for example, a battery, a DC-DC converter, a diode rectifier, a PWM rectifier, or the like may be used. The direct current power supply 3 may be provided with a voltage sensor that detects the direct current voltage Vdc. The output signal of the voltage sensor may be input to the control device 10. The control device 10 may perform control using the detected direct current voltage Vdc.

The current sensor 6 detects a current flowing through the three-phase windings Cu, Cv, and Cw. As the current sensor 6, a component capable of detecting a current, such as a resistor (shunt resistor) or a Hall element, may be employed. The current sensor 6 in the example of FIG. 1 includes three resistors Ru, Rv, and Rw. An output signal of the current sensor 6 is input to the control device 10. In the present embodiment, the three resistors Ru, Rv, and Rw are connected in series to the legs of each phase. Specifically, the resistor Ru of the U phase is connected in series to the negative electrode side of the negative electrode-side switching element SNu. The resistor Rv of the V phase is connected in series to the negative electrode side of the negative electrode-side switching element SNv. The resistor Rw of the W phase is connected in series to the negative electrode side of the negative electrode-side switching element SNw. The potential difference between both ends of the resistors Ru, Rv, and Rw of the three phases is detected by amplifiers 21, 22, and 23. The potential difference detected for both ends is input to the control device 10.

The current sensor 6 may be disposed in a path that connects the leg and the windings Cu, Cv, and Cw in each phase. In addition, the current sensor 6 may detect the current of each phase by a so-called “one shunt method”. In a case of the one shunt method, it is possible to set the number of resistors included in the current sensor 6 to one. In a case of the one shunt method, the resistor is disposed in a path connecting the power converter 4 and the direct current power supply 3.

### (Electric Power Steering Device 100)

The electric power steering device 100 includes a driving force transmission mechanism 101, a steering device 102, wheels 103, a steering wheel 104, a shaft 105, a torque sensor 106, or the like. The driving force transmission mechanism 101 transmits the driving force of the rotary electric machine 1 to the steering device 102. The driving force transmission mechanism 101 includes a worm gear or the like. It is possible for the steering device 102 to change a direction of the wheels 103. A rotation shaft of the rotor of the rotary electric machine 1 is connected to the steering device 102 via the driving force transmission mechanism 101. The shaft 105 is connected to the steering wheel 104. The shaft 105 transmits a steering torque Ts when the driver operates the steering wheel 104, to the steering device 102. The torque sensor 106 is attached to the shaft 105 and detects the steering torque Ts. An output signal of the torque sensor 106 is input to the control device 10 (an input circuit 92).

### (Control Device 10)

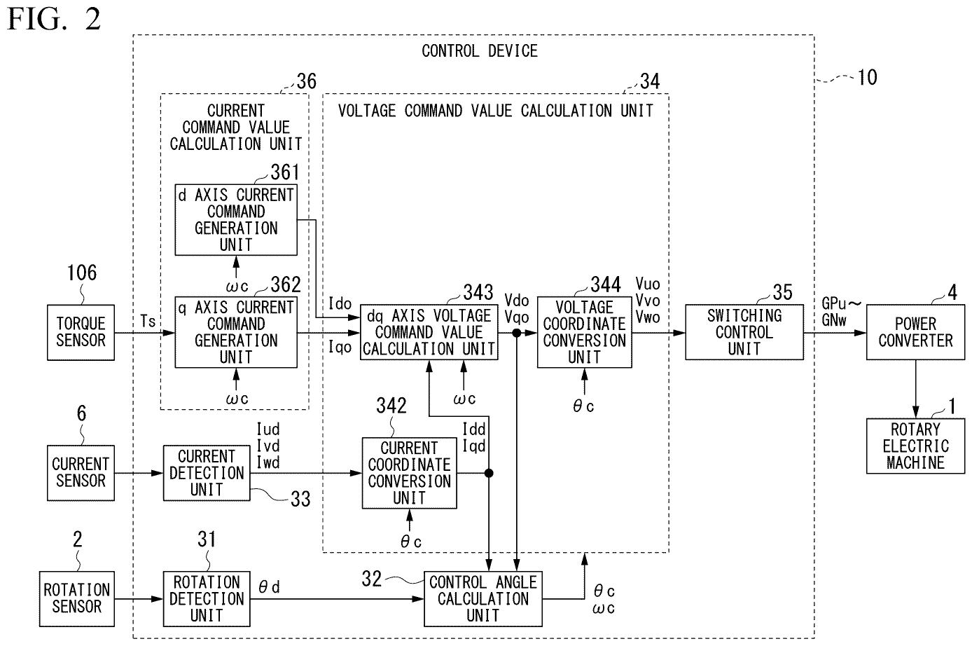

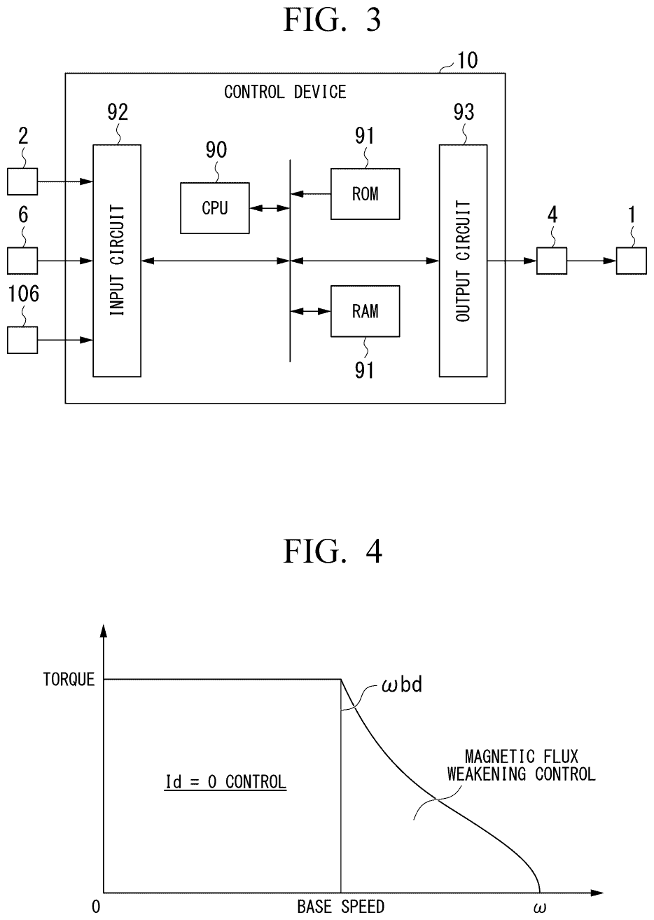

The control device 10 controls the rotary electric machine 1 via the power converter 4. FIG. 2 shows a functional block diagram of the control device 10. As shown in FIG. 2, the control device 10 includes a rotation detection unit 31, a control angle calculation unit 32, a current detection unit 33, a voltage command value calculation unit 34, a switching control unit 35, a current command value calculation unit 36, or the like. Each function of the control device 10 is realized by a processing circuit included in the control device 10. As a specific example of the “processing circuit”, as shown in FIG. 3, the control device 10 includes an arithmetic processing device 90 (computer), a storage device 91, the input circuit 92, an output circuit 93, or the like. The input circuit 92 inputs an external signal to the arithmetic processing device 90.

As the arithmetic processing device 90, a component such as a central processing unit (CPU), an application specific integrated circuit (ASIC), an integrated circuit (IC), a digital signal processor (DSP), a field programmable gate array (FPGA), various logic circuits, and various signal processing circuits may be used. In addition, the arithmetic processing device 90 may include a plurality of the same type of components described above or a plurality of different types of components. The plurality of components included in the arithmetic processing device 90 may share and execute the processing.

The storage device 91 transmits and receives data to and from the arithmetic processing device 90. As the storage device 91, a random access memory (RAM), a read only memory (ROM), or the like may be used. The RAM is configured to be writable with data read out from the arithmetic processing device 90. The ROM is configured such that the arithmetic processing device 90 may read out data.

Various sensors such as the rotation sensor 2, the current sensor 6, and the torque sensor 106, a switch, or the like are connected to the input circuit 92. The input circuit 92 includes an A/D converter or the like to input output signals of these sensors, switches, or the like to the arithmetic processing device 90. The output circuit 93 outputs a signal from the arithmetic processing device 90 to the outside. An electric load such as a gate drive circuit is connected to the output circuit 93. The “gate drive circuit” is a circuit to switch an ON/OFF of the switching elements SP and SN. The output circuit 93 outputs a control signal from the arithmetic processing device 90 to the electric load.

The arithmetic processing device 90 executes software (program) stored in the storage device 91 (for example, a ROM). The arithmetic processing device 90 works together with hardware such as the storage device 91, the input circuit 92, and the output circuit 93 to realize each function of the rotation detection unit 31, the control angle calculation unit 32, the current detection unit 33, the voltage command value calculation unit 34, the switching control unit 35, the current command value calculation unit 36, or the like. The setting data, such as an internal division ratio and a control gain used by the control device 10 are stored in the storage device 91, such as a ROM, as a part of a software. Hereinafter, each function of the control device 10 is explained in detail.

### (Basic Control)

The rotation detection unit 31 shown in FIG. 2 detects a rotational angle (a rotational angle detection value θd) of the rotor based on an output signal of the rotation sensor 2. The rotational angle detection value Od is, for example, the magnetic pole position of the rotor. The magnetic pole position is, for example, a position of a magnetic pole (N pole) of a magnet provided in the rotor with respect to a position of the winding Cu of the U phase. The magnetic pole position is represented by an electric angle. The current detection unit 33 detects currents (current detection values Iud, Ivd, Iwd) flowing through the three-phase windings Cu, Cv, and Cw based on the output signal of the current sensor 6. The current sensor 6 may be configured to detect winding currents of the two phases. In such case, the winding current of the remaining one phase may be calculated based on the detection values of the winding currents of the two phases. For example, the current sensor 6 may detect the current detection values Ivd and Iwd of the V phase and the W phase. In such case, the current detection value Iud of the U phase may be calculated by Iud=−Ivd−Iwd.

The voltage command value calculation unit 34 calculates voltage command values Vuo, Vvo, and Vwo to be applied to the three-phase windings Cu, Cv, and Cw based on a control rotational angle θc described later and current detection values Idd and Iqd described later. In the present embodiment, the voltage command value calculation unit 34 includes a current coordinate conversion unit 342, a dq axis voltage command value calculation unit 343, and a voltage coordinate conversion unit 344.

The current coordinate conversion unit 342 converts the current detection values Iud, Ivd, and Iwd of the three-phase windings Cu, Cv, and Cw into the current detection values Idd and Iqd on two rotational axes (d axis and q axis) based on the control rotational angle θc. In the present embodiment, the current coordinate conversion unit 342 performs the calculation shown in Expression (1-1). In other words, the current coordinate conversion unit 342 converts the current detection values lud, Ivd, and Iwd into values of a rotational coordinate system based on the control rotational angle θc.

$$\begin{matrix}[ Math 1 ] & \\ [ \begin{matrix}Idd \\ Iqd\end{matrix} ] = \sqrt{\frac{2}{3}} [ \begin{matrix}cos θ c & cos ( θ c - \frac{2 π}{3} ) & cos ( θ c + \frac{2 π}{3} ) \\ - sin θ c & - sin ( θ c - \frac{2 π}{3} ) & - sin ( θ c + \frac{2 π}{3} )\end{matrix} ] [ \begin{matrix}Iud \\ Ivd \\ Iwd\end{matrix} ] & ( 1 - 1 )\end{matrix}$$

The “d axis” is defined by the direction of the magnetic pole (N pole) of the magnet. The “q axis” is defined as a direction advanced by 90 degrees in the electric angle from the d axis. In the present embodiment, since the coordinate conversion is executed based on the control rotational angle θc, the direction of the control rotational angle θc matches the d axis.

The current command value calculation unit 36 includes a d axis current command generation unit 361 and a q axis current command generation unit 362. The current command value calculation unit 36 calculates a d axis current command value Ido and a q axis current command value Iqo. The current command value calculation unit 36 detects the steering torque Ts of the driver based on the output signal of the torque sensor 106. As shown in Expression (1-2), the current command value calculation unit 36 calculates the q axis current command value Iqo based on the steering torque Ts. The current command value calculation unit 36 may set the d axis current command value Ido to 0. The aforementioned is referred to as “Id=0 control”. The Id=0 control is suitable when the rotary electric machine 1 is of a surface magnet type.

$$\begin{matrix}[ Math 2 ] & \\ Iqo = Ka \times Ts & ( 1 - 2 )\end{matrix}$$

$$Ido = 0$$

In Expression (1-2), Ka is a constant. However, the value of Ka may change depending on the steering torque Ts, the traveling speed of the vehicle, or the like. The value of the q axis current command value Iqo may be set based on a known compensation control corresponding to a certain steering situation. When the rotary electric machine 1 is of an embedded magnet type, the current command values Ido and Iqo may be set by maximum torque current control instead of the Id=0 control. In the “maximum torque current control”, the current command values Ido and Iqo are calculated such that the generated torque is maximized for the same current. In a region where a rotational angular velocity ω is high, magnetic flux weakening control may be executed. In the “magnetic flux weakening control”, the d axis current command value Ido is increased in the negative direction with respect to a value calculated by the “Id=0 control” or the “maximum torque current control”. The magnetic flux weakening control may be executed, for example, when the rotational angular velocity ω is equal to or higher than a base speed. The “base speed” is a speed at which the amplitude of the line-to-line voltage output by the inverter (the power converter 4) reaches the direct current voltage Vdc.

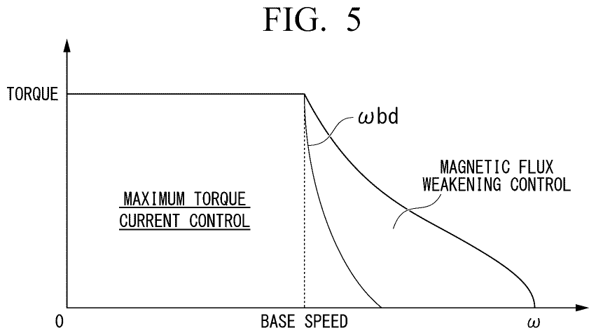

FIG. 4 shows an execution region of each control in a case where “Id=0 control” and “magnetic flux weakening control” are performed in the rotary electric machine 1 of a surface magnet type. FIG. 5 shows an execution region of each control in a case where the “maximum torque current control” and the “magnetic flux weakening control” are performed in the rotary electric machine 1 of an embedded magnet type.

The dq axis voltage command value calculation unit 343 outputs a d axis voltage command value Vdo and a q axis voltage command value Vqo. In addition, the dq axis voltage command value calculation unit 343 performs the current feedback control that changes the voltage command values Vdo and Vqo that are output, by PI control or the like. In the current feedback control, the d axis current detection value Idd approaches the d axis current command value Ido, and the q axis current detection value Iqd approaches the q axis current command value Iqo. Specifically, the dq axis voltage command value calculation unit 343 executes the calculation based on Expression (1-3).

$$\begin{matrix}[ Math 3 ] & \\ Vdo = Kd ( 1 + \frac{1}{Td \times s} ) ( Ido - Idd ) & ( 1 - 3 )\end{matrix}$$

$$Vqo = Kq ( 1 + \frac{1}{Tq \times s} ) ( Iqo - Iqd )$$

Here, Kd and Kq are proportional gains, Td and Tq are integration time constants, and s is a Laplace operator. A feedforward control for non-interference of the d axis current and the q axis current may be performed. In other words, “−ωc×Lq×Iqc” may be added to the d axis voltage command value Vdo, and “ωc×(Ld×Idc+ψ)” may be added to the q axis voltage command value Vqo. Here, ωc is a rotation speed for control described below. The control rotation speed ωc may be represented as an angular velocity or may be represented as a rotational speed. A detection value ωd of a rotational angular velocity, which is described later, may be used instead of ωc. Lq is an inductance value of the q axis, Ld is an inductance value of the d axis, and ψ is a mutual inductance magnetic flux in which a magnetic force of the magnet is mutually induced in the winding.

The voltage coordinate conversion unit 344 converts the voltage command values Vdo and Vqo on the two rotational axes (the d axis and the q axis) into the voltage command values Vuo, Vvo, and Vwo of the three phases based on the control rotational angle θc. In the present embodiment, the voltage coordinate conversion unit 344 performs the calculation shown in Expression (1-4). In other words, the voltage coordinate conversion unit 344 converts the voltage command values Vdo and Vqo into values of a fixed coordinate system based on the control rotational angle θc.

$$\begin{matrix}[ Math 4 ] & \\ [ \begin{matrix}Vuo \\ Vvo \\ Vwo\end{matrix} ] = \sqrt{\frac{2}{3}} [ \begin{matrix}cos θ c & - sin θ c \\ cos ( θ c - \frac{2 π}{3} ) & - sin ( θ c - \frac{2 π}{3} ) \\ cos ( θ c + \frac{2 π}{3} ) & - sin ( θ c + \frac{2 π}{3} )\end{matrix} ] [ \begin{matrix}Vdo \\ Vqo\end{matrix} ] & ( 1 - 4 )\end{matrix}$$

The voltage coordinate conversion unit 344 may add known modulation such as two-phase modulation and third-order harmonic superimposition to the voltage command values Vuo, Vvo, and Vwo of the three phases.

The switching control unit 35 switches the ON/OFF of the switching elements SP and SN included in the power converter 4 based on the voltage command values Vuo, Vvo, and Vwo of the three phases. The switching control unit 35 uses a known carrier comparison PWM or space vector PWM. When the carrier comparison PWM is used, the switching control unit 35 compares a carrier wave with each of the voltage command values Vuo, Vvo, and Vwo of the three phases. Based on the comparison result, the switching control unit 35 switches the ON/OFF of the switching elements SP and SN. The “carrier wave” is, for example, a triangular wave. In the triangular wave, the amplitude may be centered around zero with a value (Vdc/2) that is half of the direct current voltage Vdc in a PWM cycle Tc.

When the carrier wave falls below the voltage command value for each phase, the switching control unit 35 turns on a switching signal GP directed to the positive electrode-side switching element SP. Accordingly, the positive electrode-side switching element SP is in an ON state. When the carrier wave exceeds the voltage command value for each phase, the switching control unit 35 turns off the switching signal GP directed to the positive electrode-side switching element SP. Accordingly, the positive electrode-side switching element SP is in an OFF state.

When the carrier wave falls below the voltage command value for each phase, the switching control unit 35 turns off a switching signal GN directed to the negative electrode-side switching element SN. Accordingly, the negative electrode-side switching element SN is in an OFF state. When the carrier wave exceeds the voltage command value for each phase, the switching control unit 35 turns on the switching signal GN directed to the negative electrode-side switching element SN. Accordingly, the negative electrode-side switching element SN is in an ON state.

For each phase, a short-circuit prevention period (dead time) for turning off both the switching elements SP and SN may be provided between the on period of the positive electrode-side switching element SP and the on period of the negative electrode-side switching element SN.

When a space vector PWM is used, the switching control unit 35 may generate a voltage command vector from the voltage command values Vuo, Vvo, and Vwo of the three phases. The switching control unit 35 may determine the output time allocation of seven basic voltage vectors in a PWM cycle based on the voltage command vector. Further, the switching control unit 35 may generate a switching signal for switching on and off of each of the switching elements SP and SN in the PWM cycle based on the output time allocation of the seven basic voltage vectors.

### (Control Angle Calculation Unit 32)

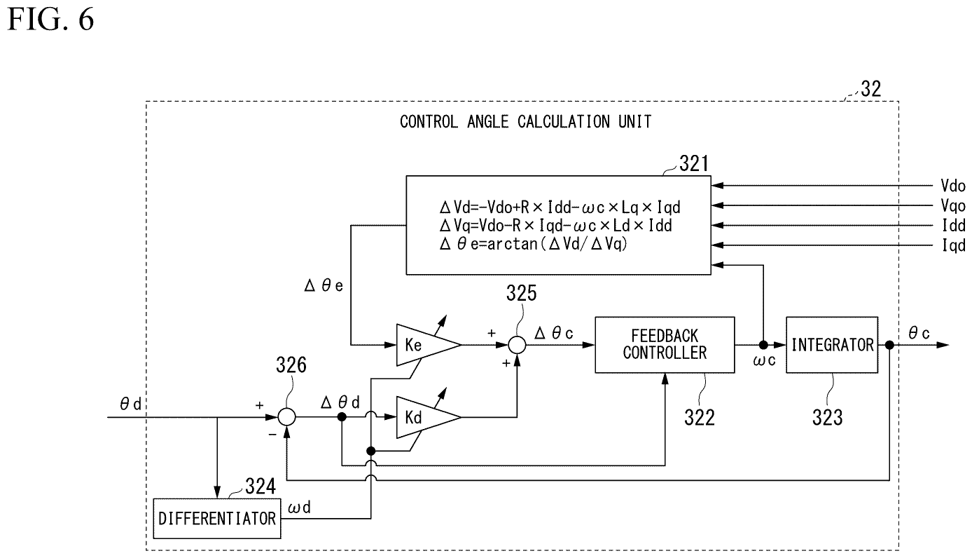

FIG. 6 shows a functional block diagram of the control angle calculation unit 32 according to the present embodiment. The control angle calculation unit 32 includes an estimation unit 321, a feedback controller 322, an integrator 323, a differentiator 324, an adder 325, a subtractor 326, or the like. The estimation unit 321 estimates an estimated actual angle deviation Δθe based on the electrical constant of the rotary electric machine 1, the information on the current detection value, and the information on the voltage command value. The “estimated actual angle deviation Δθe” is a deviation of the control rotational angle θc with respect to the true rotational angle of the rotor. The subtractor 326 calculates a detection angle deviation Δθd. The “detection angle deviation Δθd” is a deviation of the control rotational angle θc with respect to the rotational angle detection value θd.

The control angle calculation unit 32 calculates a value that internally divides the estimated actual angle deviation Δθe and the detection angle deviation Δθd as a control angle deviation Δθc. The term “internal division” is described later. The control angle calculation unit 32 calculates the control rotational angle θc by performing feedback control such that the control angle deviation Δθc approaches 0.

When a velocity proportional physical quantity is higher than a preset velocity threshold value Th, the control angle calculation unit 32 increases a ratio Ke of the estimated actual angle deviation Δθe relative to a ratio Kd of the detection angle deviation Δθd in the control angle deviation Δθc. In addition, when the velocity proportional physical quantity is lower than the velocity threshold value Th, the control angle calculation unit 32 decreases the ratio Ke relative to the ratio Kd of the detection angle deviation Δθd. Here, the “velocity proportional physical quantity” is a physical quantity that is proportional to the rotation speed of the rotor. Specifically, the velocity proportional physical quantity may be an angular velocity of the rotor or a rotational speed of the rotor.

<Calculation of Detection Angle Deviation Δθd>

As shown in Expression (1-5), the subtractor 326 calculates the detection angle deviation Δθd by subtracting the control rotational angle θc from the rotational angle detection value θd.

$$\begin{matrix}[ Math 5 ] & \\ Δ θ d = θ d - θ c & ( 1 - 5 )\end{matrix}$$

<Calculation of Estimated Actual Angle Deviation Δθe>

As described above, the estimation unit 321 estimates the estimated actual angle deviation Δθe, which is a deviation of the control rotational angle θc with respect to the true rotational angle of the rotor, based on the information on the current detection value, the electrical constant of the rotary electric machine, and the information on the voltage command value. In the present embodiment, the estimation unit 321 estimates the estimated actual angle deviation Δθe based on the d axis and q axis current detection values Idd and Iqd, the d axis and q axis voltage command values Vdo and Vqo, and the control rotation speed ωc.

Specifically, the estimation unit 321 calculates the estimated actual angle deviation Δθe by using Expression (1-6).

$$\begin{matrix}[ Math 6 ] & \\ Δ Vd = - Vdo + R \times Idd - ω c \times Lq \times Iqd & ( 1 - 6 )\end{matrix}$$

$$Δ Vq = Vqo - R \times Iqd - ω c \times Ld \times Idd$$

$$Δθ e = arctan ( Δ Vd / Δ Vq )$$

Here, R is a resistance value of the preset windings Cu, Cv, and Cw. The d axis and q axis inductance values Ld and Lq may be set using map data of the d axis current and the q axis current in consideration of the magnetic saturation of a permanent magnet. Expression (1-6) is derived based on a voltage equation. ΔVd is an error of the d axis voltage caused by the deviation of the control rotational angle θc from the actual rotational angle (here, the rotational angle at which the voltage equation is satisfied). ΔVq is an error of the q axis voltage caused by the deviation of the control rotational angle θc from the actual rotational angle. The estimated actual angle deviation Δθe is then calculated as the value of the arctangent function of ΔVd/ΔVq.

Instead of the control rotation speed ωc, the detection value ωd of a rotational angular velocity calculated by differentiating the rotational angle detection value Od may be used. Instead of the d axis and q axis voltage command values Vdo and Vqo, d axis and q axis voltage detection values Vdd and Vqd may be used. In such case, the voltage detection values Vdd and Vqd are obtained by performing the three-phase two-phase conversion and the rotational coordinate conversion on voltage detection values Vu_PWM, Vv_PWM, and Vw_PWM of the three phases based on the control rotational angle θc. In addition, in order to obtain the voltage detection values Vdd and Vqd, the results (the voltage detection values Vu_PWM, Vv_PWM, and Vw_PWM) obtained by detecting the voltages applied to the three-phase winding are used.

When the absolute value of the detection value ωd of the rotational angular velocity is smaller than a threshold value, the estimation unit 321 may set Δθe=0. In other words, the calculation of the estimated actual angle deviation Δθe by using Expression (1-6) may be stopped. This is because, when the rotational angular velocity is low, the error ΔVq of the q axis voltage is close to 0, the ΔVd/ΔVq is excessively large, which prevents the calculation error of Δθe from being excessively large.

### <Calculation of Detection Value ωd of Rotational Angular Velocity>

The differentiator 324 calculates the detection value ωd of the rotational angular velocity by using Expression (1-7).

$$\begin{matrix}[ Math 7 ] & \\ ω d ( n ) = \{ θ d ( n ) - θ d ( n - 1 ) \} / Δ T & ( 1 - 7 )\end{matrix}$$

Here, “θd(n−1)” is a rotational angle detected at the previous calculation timing, and “θd(n)” is a rotational angle detected at the current calculation timing. *

ΔT is a calculation cycle. As the detection value ωd of the rotational angular velocity, a value obtained by performing low-pass filter processing on the calculated value of Expression (1-7) may be used.

### <Calculation of Control Angle Deviation Δθc by Internal Division>

The adder 325 calculates the control angle deviation Δθc as shown in Expression (1-8). Specifically, the adder 325 adds a value obtained by multiplying the estimated actual angle deviation Δθe by the internal division ratio Ke of the estimated actual angle deviation, and a value obtained by multiplying the detection angle deviation Δθd by the internal division ratio Kd of the detection angle deviation Δθd.

$$\begin{matrix}[ Math 8 ] & \\ Δ θ c = K e \times Δ θ e + K d \times Δθ d & ( 1 - 8 )\end{matrix}$$

$$Ke + Kd = 1 , 0 ≦ Ke ≦ 1 , 0 ≦ Kd ≦ 1$$

Here, the internal division ratio Ke is a ratio of the estimated actual angle deviation Δθe in the control angle deviation Δθc. The internal division ratio Kd is a ratio of the detection angle deviation Δθd in the control angle deviation Δθc. The internal division ratio Ke and the internal division ratio Kd are each set within a range greater than or equal to 0 and less than or equal to 1, so that a total value of the internal division ratio Ke and the internal division ratio Kd is 1. In other words, Kd=1−Ke. Accordingly, (Δθc−Δθe):(Δθd−Δθc)=Ke:(1−Ke) is satisfied. In other words, the control angle deviation Δθc is a value that internally divides the estimated actual angle deviation Δθe and the detection angle deviation Δθd in a ratio of Ke:(1−Ke).

### <Change in Internal Division Ratio in Response to Velocity Proportional Physical Quantity>

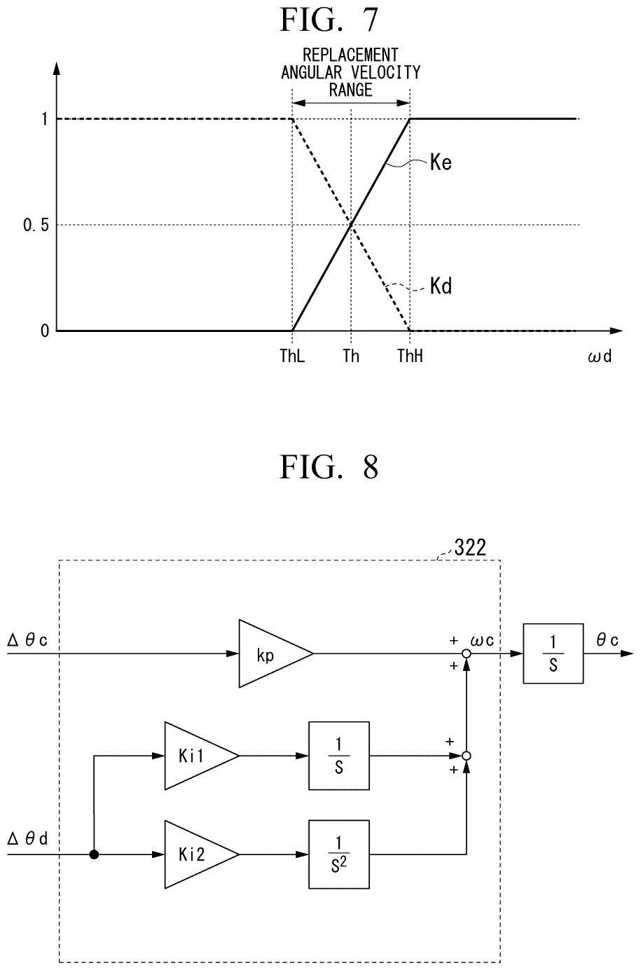

FIG. 7 shows a setting example of the internal division ratios Ke and Kd according to the present embodiment. In the present embodiment, as the velocity proportional physical quantity, the detection value ωd of the rotational angular velocity is used. When the detection value ωd of the rotational angular velocity is higher than the preset velocity threshold value Th, the control angle calculation unit 32 increases the internal division ratio Ke relative to the internal division ratio Kd. When the detection value od of the rotational angular velocity is lower than the velocity threshold value Th, the control angle calculation unit 32 decreases the internal division ratio Ke relative to the internal division ratio Kd.

More specifically, when the detection value ωd of the rotational angular velocity is higher than the velocity threshold value Th, the control angle calculation unit 32 increases the internal division ratio Ke relative to 0.5 and decreases the internal division ratio Kd relative to 0.5. In addition, when the detection value ωd of the rotational angular velocity is lower than the velocity threshold value Th, the control angle calculation unit 32 decreases the internal division ratio Ke relative to 0.5 and increases the internal division ratio Kd relative to 0.5. The control rotation speed ωc may be used instead of the detection value ωd of the rotational angular velocity.

The control angle calculation unit 32 continuously increases the internal division ratio Ke and continuously decreases the internal division ratio Kd as the detection value od of the rotational angular velocity increases in a range of the velocity proportional physical quantity that is preset. The “range of the velocity proportional physical quantity” is set to include the velocity threshold value Th. In the present embodiment, a case where the velocity proportional physical quantity is the rotational angular velocity is explained. Hereinafter, the “range of the velocity proportional physical quantity” may be referred to as a “replacement angular velocity range”.

As shown in FIG. 7, the replacement angular velocity range is a range from a lower limit angular velocity ThL to an upper limit angular velocity ThH. The lower limit angular velocity ThL is a value lower than the velocity threshold value Th by a predetermined value. The upper limit angular velocity ThH is a value higher than the velocity threshold value Th by a predetermined value. In the example shown in FIG. 7, the replacement angular velocity range is set such that the velocity threshold value Th is the center of the replacement angular velocity range.

In the example of FIG. 7, the internal division ratios Ke and Kd are continuously changed in a replacement speed range. With such configuration, when there is a difference between the estimated actual angle deviation Δθe and the detection angle deviation Δθd, it is possible to suppress a sharp change in the control angle deviation Δθc. In addition, it is possible to suppress a sharp change in the control rotational angle θc and a sharp change in the torque. As a result, it is possible to suppress deterioration of a steering feel felt by the driver. In the vicinity (within the replacement speed range) of the velocity threshold value Th, the internal division ratios Ke and Kd may be changed stepwise.

As described above, in the replacement angular velocity range, the control angle calculation unit 32 continuously increases the internal division ratio Ke from 0 to 1 and continuously decreases the internal division ratio Kd from 1 to 0 as the detection value od of the rotational angular velocity increases. When the detection value ωd of the rotational angular velocity is lower than the replacement angular velocity range, the control angle calculation unit 32 sets the internal division ratio Ke to 0 and sets the internal division ratio Kd to 1. When the detection value ωd of the rotational angular velocity is higher than the replacement angular velocity range, the control angle calculation unit 32 sets the internal division ratio Ke to 1 and sets the internal division ratio Kd to 0.

### <Setting of Velocity Threshold Value Th Corresponding Tt Execution Region of Magnetic Flux Weakening Control>

The velocity threshold value Th is set to correspond to a rotational angular velocity ωbd. As shown in FIGS. 4 and 5, the rotational angular velocity ωbd is a boundary between an execution region of the “Id=0 control” or the “maximum torque current control” and an execution region of the magnetic flux weakening control. Hereinafter, the effect obtained by such a setting is explained.

When the detection angle deviation Δθd is present, it is possible to approximate a torque error ΔTerr as follows.

$$\begin{matrix}[ Math 9 ] & \\ Δ Terr \approx Iq \times cos ( Δθ d ) + Id \times sin ( Δθ d ) & ( 1 - 9 )\end{matrix}$$

Although the detection error is present, the detection angle deviation Δθd is a value close to 0. Therefore, cos(Δθd)<<sin(Δθd) is satisfied, and the first term on the right side of Expression (1-9) may be ignored. The torque error ΔTerr therefore increases as the absolute value of a d axis current Id increases. As described above, in the magnetic flux weakening control, the d axis current command value Ido is increased in the negative direction with respect to the d axis current command value calculated by the “Id=0 control” or the “maximum torque current control”. Therefore, in the execution region of the magnetic flux weakening control, the absolute value of the d axis current Id increases. As a result, the torque error ΔTerr increases due to the presence of the detection angle deviation Δθd.

Here, by setting the velocity threshold value Th as described above, the internal division ratio Ke is increased in the execution region of the magnetic flux weakening control. The control rotational angle θc is calculated such that the estimated actual angle deviation Δθe decreases. Therefore, the deviation (the estimated actual angle deviation Δθe) of the control rotational angle θc with respect to the true rotational angle decreases, and the detection angle deviation Δθd decreases. As explained using Expression (1-6), the true rotational angle is a rotational angle in which the voltage equation is satisfied. The torque error ΔTerr of Expression (1-9) is also derived based on the voltage equation. By calculating the control rotational angle θc such that the estimated actual angle deviation Δθe decreases, it is possible to decrease the torque error ΔTerr.

When the induced voltage is high, the calculation accuracy of the estimated actual angle deviation Δθe in Expression (1-6) tends to be high. In other words, in a region where the induced voltage is high and the magnetic flux weakening control is executed, the internal division ratio Ke of the estimated actual angle deviation Δθe increases, so that it is possible to reduce the detection angle deviation Δθd.

In the present embodiment, when the detection value ωd of the rotational angular velocity is greater than the lower limit angular velocity ThL of the replacement angular velocity range, the estimated actual angle deviation Δθe is reflected in the calculation of the control rotational angle θc. Therefore, the velocity threshold value Th and the replacement angular velocity range may be set such that the rotational angular velocity ωbd of the boundary between the execution region of the “Id=0 control” or the “maximum torque current control” and the execution region of the magnetic flux weakening control is greater than or equal to the lower limit angular velocity ThL of the replacement angular velocity range. For example, the velocity threshold value Th may be set to match the rotational angular velocity ωbd of the boundary. Alternatively, the velocity threshold value Th and the replacement angular velocity range may be set such that the rotational angular velocity ωbd of the boundary is included in the replacement angular velocity range.

As shown in FIG. 5, in a case of the embedded magnet type rotary electric machine, the rotational angular velocity ω bd of the boundary changes depending on the torque. Therefore, the velocity threshold value Th and the replacement angular velocity range may be changed according to the torque. Alternatively, in the embedded magnet type rotary electric machine, even during the maximum torque current control, the d axis current has a value smaller than 0, so that the velocity threshold value Th and the replacement angular velocity range may be set in the execution region of the maximum torque current control.

As the velocity proportional physical quantity, the control rotation speed ωc may be used. As the velocity proportional physical quantity, a physical quantity other than the rotation speed may be used. For example, the induced voltage generated in the winding is proportional to the rotational angular velocity, and the applied voltage of the winding is proportional to the induced voltage. As the velocity proportional physical quantity, the magnitudes of the voltage vectors of the d axis and q axis voltage command values Vdo and Vqo may be used. Alternatively, as the velocity proportional physical quantity, the sum of the square of Vdo and the square of Vqo may be used.

When the direct current voltage Vdc is lower than the voltage threshold value, the control angle calculation unit 32 may fix the internal division ratio Ke to 0 and fix the internal division ratio Kd to 1. In other words, the estimated actual angle deviation Δθe may not be reflected in the control angle deviation Δθc. As a reason, as the direct current voltage Vdc decreases, the base speed decreases, and the magnetic flux weakening control is performed from a lower rotation speed. In the aforementioned case, due to the induced voltage being low at the lower rotation speed, the estimation accuracy of the estimated actual angle deviation Δθe by Expression (1-6) decreases.

### <Configuration of Feedback Controller and Effect Thereof>

FIG. 8 shows an example configuration of the feedback controller 322 included in the control angle calculation unit 32. As shown in FIG. 8, the feedback controller 322 includes two adders. The control rotation speed ωc is calculated by these adders.

Specifically, the control rotation speed ωc is calculated by adding a “value obtained by multiplying the control angle deviation Δθc by a proportional gain kp”, a “value obtained by multiplying the detection angle deviation Δθd by an integral gain Ki1 and integrating the result once”, and a “value obtained by multiplying the detection angle deviation Δθd by a double integral gain Ki2 and integrating the result twice”. In addition, the control rotational angle θc is calculated by integrating the control rotation speed ωc.

In such configuration, when the control rotational angle θc is obtained based on the control angle deviation Δθc and the detection angle deviation Δθd, feedback control is performed such that the values of Δθc and Δθd approach 0. In such configuration, the control angle deviation Δθc and the detection angle deviation Δθd approach 0, but, when there is a steady-state error or a direct current error in both of the control angle deviation Δθc and the detection angle deviation Δθd, Δθc and Δθd do not simultaneously become 0. The aforementioned point is described later.

As described above, the control angle calculation unit 32 calculates the control rotational angle θc by performing the feedback control such that the control angle deviation Δθc approaches 0. Therefore, it is possible to suppress the error of the alternating current component included in the detection value (the rotational angle detection value θd) by the rotation sensor 2 from being reflected in the control rotational angle θc, and it is possible to have the control rotational angle θc approach to the true rotational angle. As described above, it is possible to have the rotary electric machine 1 rotate quietly by reducing the error (torque ripple) of the alternating current component.

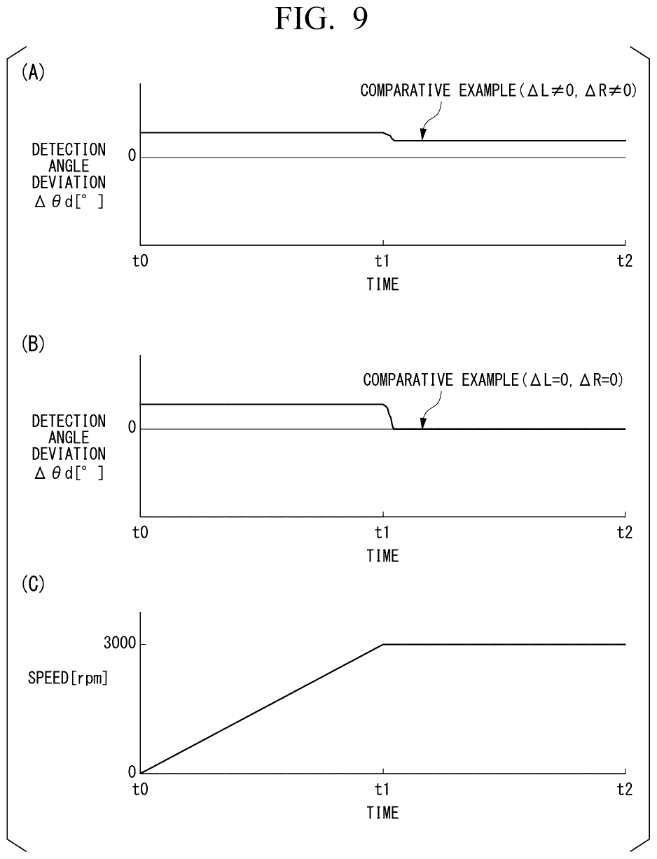

Next, a problem in the related art is explained with reference to FIG. 9. FIG. 9 (A) to (C) show graphs when the configuration of the feedback controller described in Patent Document 1 is used as a comparative example. FIG. 9 (A) to (C) show a relationship between the detection angle deviation Δθd and the rotation speed (rotational speed) of the rotor at that time in the comparative example. In the aforementioned example, a case where a difference is generated in the d axis and q axis inductance values Ld and Lq preset in the feedback controller with respect to actual d axis and q axis inductance values Ld_real and Lq_real of the rotary electric machine 1 is provided. Alternatively, a case where a difference is generated in a preset resistance value R in the feedback controller with respect to the actual resistance value R_real of the rotary electric machine is provided. FIG. 9 (B) shows the detection angle deviation Δθd derived when the electrical constants (Ld, Lq, and R) preset in the feedback controller match the actual electrical constants (Ld_real, Lq_real, and R_real) of the rotary electric machine 1.

In FIG. 9 (C), the rotation speed varies from 0 rpm to 3000 rpm between time t0 to time t1, and is constant at 3000 rpm between time t1 to time t2. Hereinafter, explanations are made using classification into “between time t0 and t1 (speed variation section)” and “between time t1 and t2 (constant speed section)”.

In the “between time t1 and t2 (constant speed section)”, the detection angle deviation Δθd does not match 0° in FIG. 9 (A), and the detection angle deviation Δθd matches 0° in FIG. 9 (B). In other words, under the condition that the rotation speed is constant, whether or not the direct current component (DC component) of the detection angle deviation Δθd match 0° is determined depending on whether or not the “electrical constant preset in the feedback controller” matches the “actual electrical constant of the rotary electric machine 1”. The aforementioned is referred to as “problem A”.

In the “between time t0 and t1 (speed variation section)”, the direct current component of the detection angle deviation Δθd does not match 0° regardless of whether or not the “electrical constant preset in the feedback controller” matches the “actual electrical constant of the rotary electric machine”. The aforementioned is referred to as “problem B”.

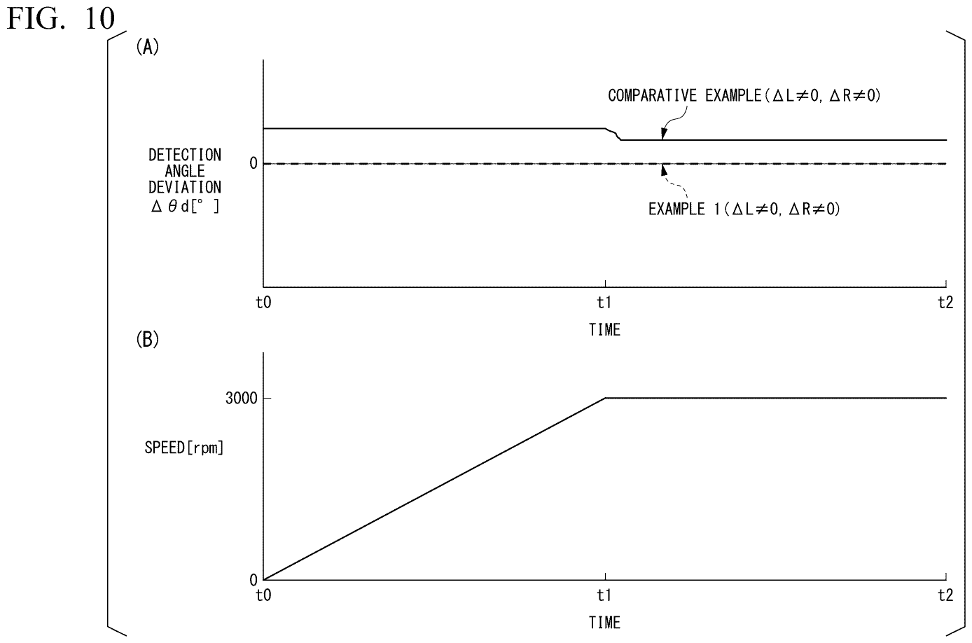

In order to solve the above-described problems A and B, the feedback controller 322 in the present embodiment is configured as shown in FIG. 8. First, the control rotational angle θc is calculated by using the “value obtained by multiplying the detection angle deviation Δθd by the integral gain Ki1 and integrating the result once”. With such configuration, the feedback control is performed such that the direct current integration of Δθd is 0. “Example 1” of FIG. 10 shows a case where the feedback controller 322 (see FIG. 8) according to the present embodiment is applied.

According to the configuration of FIG. 8, as shown in “Example 1” of FIG. 10, when the “electrical constant preset in the feedback controller 322” does not match the “actual electrical constant of the rotary electric machine 1”, the detection angle deviation Δθd may be set to approximately 0° in the “between time t1 and t2 (constant speed section)”.

In addition, for problem B, the feedback controller 322 shown in FIG. 8 calculates the control rotational angle θc by using the “value obtained by multiplying the detection angle deviation Δθd by the double integral gain Ki2 and integrating the result twice”. With such configuration, an effect of suppressing the ramp variation of the rotation speed applies. As a result, as shown in “Example 1” of FIG. 10, the detection angle deviation Δθd may be set to approximately 0° even in “between time t0 and t1 (speed variation section)”.

<Response Frequency from Δθc to θc>

Here, in FIG. 9 of Non-Patent Document 1, “Control Method of Reducing Steering Torque of Electric Power Steering” (Kuri Shige et al., Journal of the Japan Society of Mechanical Engineers (C), Vol. 68, No. 675), a steering speed of the steering oscillates at approximately 35 Hz. Specifically, in FIG. 9 of Non-Patent Document 1, it is about 3.5 cycles in 0.1 s. In other words, the true speed variation of the steering may occur at such frequency. Therefore, the response from the control angle deviation Δθc to the control rotational angle θc is required to be greater than or equal to 35 Hz. In order to ensure flexibility in control, the response from the control angle deviation Δθc to the control rotational angle θc is preferably 90 to 100 Hz, which is about three times 35 Hz, and more preferably greater than or equal to 175 Hz, which is five times 35 Hz. The vibration frequency of the rotational angular velocity corresponds to a resonance frequency of a mechanical power transmission mechanism connected to the rotation shaft of the rotor.

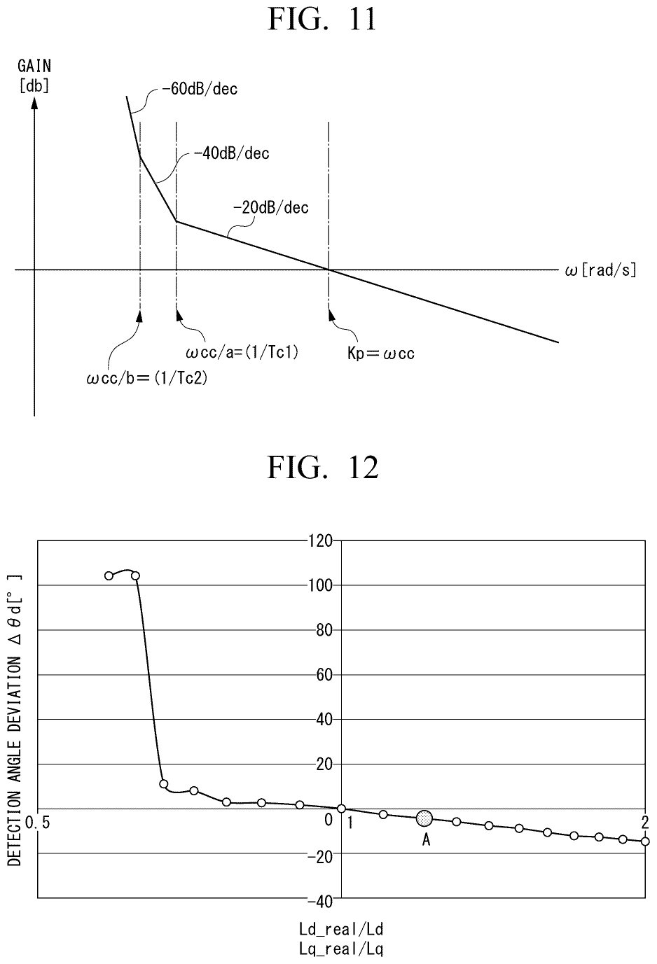

Next, a method of setting the proportional gain Kp, the integral gain Ki1, and the double integral gain Ki2 shown in FIG. 8 is described. FIG. 11 is an example showing a preferable transfer function G (gain characteristic) from the control angle deviation Δθc and the detection angle deviation Δθd to the control rotational angle θc in the feedback controller 322 of the present embodiment. In FIG. 11, the gain intersection frequency is denoted by “ωcc”, the first inflection point frequency (inflection point between −40 dB/dec and −20 dB/dec) is denoted by “1/Tc1”, and the second inflection point frequency (inflection point between −60 dB/dec and −40 dB/dec) is denoted by “1/Tc2”. In addition, assuming that K1=ωcc/(Tc1·Tc2), Expression (1-10) is satisfied.

$$\begin{matrix}[ Math 10 ] & \\ G ( s ) = θ c / Δ θ c \approx ( K 1 / s \times s \times s ) \times ( 1 + Tc 1 \times s ) \times ( 1 + Tc 2 \times s ) \approx ( 1 / s \times s \times s ) \times \{ ( K 1 \times Tc 1 \times Tc 2 ) + s \times s + K 1 \times ( Tc 1 + Tc 2 ) \times s + K 1 \} & ( 1 - 10 )\end{matrix}$$

In Expression (1-10), “≈” takes into consideration that Δθc=Δθd is satisfied when the direct current component is excluded.

In the feedback controller 322 of FIG. 8, the transfer function G from the control angle deviation Δθc and the detection angle deviation Δθd to the control rotational angle θc is represented by Expression (1-11).

$$\begin{matrix}[ Math 11 ] & \\ G ( s ) = θ c / Δ θ c \approx ( 1 / s ) \times ( Kp + Ki 1 / s + Ki 2 / ( s \times s ) ) \approx ( 1 / ( s \times s \times s ) ) \times ( Kp \times ( s \times s ) + Ki 1 \times s + Ki 2 ) & ( 1 - 11 )\end{matrix}$$

Here, the characteristics shown in FIG. 11 are obtained by setting the proportional gain Kp, the integral gain Ki1, and the integral gain Ki2 in FIG. 8 such that Expression (1-11) is equal to Expression (1-10). By comparing the coefficients of Expression (1-11) and Expression (1-10), Expression (1-12) is obtained.

$$\begin{matrix}[ Math 12 ] & \\ Kp = K 1 \times ( Tc 1 \times Tc 2 ) = ω cc & ( 1 - 12 )\end{matrix}$$

$$Ki 1 = K 1 \times ( Tc 1 + Tc 2 ) = ω cc \times ( Tc 1 + Tc 2 ) / ( Tc 1 \times Tc 2 )$$

$$Ki 2 = K1 = ω cc / ( Tc 1 \cdot Tc 2 )$$

Here, based on Expression (1-10), in FIG. 11, it is possible to represent “ωcc/a” which is the first inflection point frequency and “ωcc/b” which is the second inflection point frequency as follows:

$$ω cc / a = 1 / ( Tc 1 )$$

$$ω cc / b = 1 / ( Tc 2 )$$

However, in Expression (1-10), a and b are values greater than 1, and a<b is satisfied. The values of a and b are determined after considering the convergence of the angle error with respect to ΔR and ΔL, or the rotational acceleration of the rotary electric machine 1. ΔR is a deviation of the actual resistance value R_real of the rotary electric machine 1 with respect to the resistance value R set in the feedback controller 322. ΔL is a deviation of the actual inductance values Ld_real and Lq_real of the rotary electric machine 1 with respect to d axis and q axis inductance values Ld and Lq set in the feedback controller 322.

In FIG. 11, the transfer function G is 0 dB at ω=ωcc [rad/s]. In the closed-loop characteristics, the cutoff frequency is a characteristic of a first-order low-pass filter of the proportional gain ωcc [rad/s]. Here, the reason why the first-order low-pass filter is used is that the gain is-20 dB/dec near 0 dB. Therefore, when the rotational angular velocity ω is less than or equal to the proportional gain kp, the response from the control angle deviation Δθc and the detection angle deviation Δθd to the control rotational angle θc is such that θc responds in a manner that causes Δθd=0. When the rotational angular velocity ω exceeds ωc, it is not possible for θc to follow the variations of Δθc and Δθd.

The fact that the response from Δθc and Δθd to θc is required to be greater than or equal to 35 Hz means that the proportional gain Kp (=ωcc) is required to be greater than or equal to 2π×35 [rad/s]. Further, in order to comfortably set the response to 90 to 100 Hz, which is about three times 35 Hz, it is necessary to set the proportional gain Kp to 2π×90 to 2π×100 [rad/s]. In order to set the response to be greater than or equal to 175 Hz, which is five times the above value, it is necessary to set the proportional gain Kp to be greater than or equal to 2π×175 [rad/s]. As described above, the proportional gain Kp is at least 2π×35 [rad/s], preferably 2π×90 to 2π×100 [rad/s], which is about three times the above value to ensure flexibility, and more preferably greater than or equal to 2π×175 [rad/s].

By setting the proportional gain Kp in such fashion, it is possible to increase the response frequency (cutoff frequency) from the control angle deviation Δθc input to the proportional gain Kp to the control rotational angle θc relative to the frequency of 35 Hz of the true speed variation. Accordingly, it is possible to have the control rotational angle θc follow the true speed variation, and it is possible to suppress the generation of the torque variation due to the angle error. In addition, the high-frequency vibration components of Δθc and Δθd caused by the noise components included in the current detection value or the noise components included in the angle detection value may be configured so as to be cut off and not reflect in the control rotational angle θc.

As described above, it is preferable to set the response frequency (cutoff frequency) from the control angle deviation Δθc to the control rotational angle θc to a value between three times and five times the frequency of the true speed variation (for example, greater than or equal to 90 Hz). Accordingly, it is possible to have the control rotational angle θc follow the true speed variation, and it is possible to have the influence of the noise component of the current detection value be less likely received. As a result, it is possible to reduce the torque variation, and it is possible to have the rotary electric machine 1 become quieter.

The feedback controller 322 inputs the detection angle deviation Δθd to the integral gains Ki1 and Ki2, and performs feedback control such that the detection angle deviation Δθd approaches 0. Accordingly, when a difference is generated between the electrical constants (Ld, Lq, and R) preset in the feedback controller 322 and the actual electrical constants (Ld_real, Lq_real, and R_real) of the rotary electric machine 1, it is possible to suppress an increase in the error of the direct current component included in the estimated actual angle deviation Δθe.

In addition, the response frequency (cutoff frequency) from Δθc and Δθd to θc is decreased relative to the rotation frequency corresponding to the velocity threshold value Th. According to the aforementioned configuration, in a region where the rotation speed is higher than the velocity threshold value Th and the internal division ratio Ke of the estimated actual angle deviation Δθe is higher than the internal division ratio Kd of the detection angle deviation Δθd, the noise component of the rotation frequency included in the current detection value or the like can be suppressed from being reflected in the control rotational angle θc.

In addition, the response frequency (cutoff frequency) from Δθc and Δθd to θc is increased relative to a mechanical resonance frequency (for example, 35 Hz) generated at the rotation speed of the rotor. In particular, the response frequency (cutoff frequency) from Δθc to θc may be set to a value between three times to five times the mechanical resonance frequency generated at the rotation speed of the rotor. According to the aforementioned configuration, it is possible to have the control rotational angle θc follow the variation of the mechanical rotational angular velocity, and it is possible to have the influence of the high-frequency noise component be less likely received.

In the above description, when the velocity proportional physical quantity is higher than the preset velocity threshold value Th, the control angle calculation unit 32 increases the ratio Ke of the estimated actual angle deviation Δθe relative to the ratio Kd of the detection angle deviation Δθd in the control angle deviation Δθc. In addition, when the velocity proportional physical quantity is lower than the velocity threshold value Th, the ratio Ke of the estimated actual angle deviation Δθe in the control angle deviation Δθc is decreased relative to the ratio Kd of the detection angle deviation Δθd. However, the control angle calculation unit 32 may always set Kd=1 and Ke=0 regardless of the velocity proportional physical quantity.

When Kd=1 and Ke=0, the estimated actual angle deviation Δθe is not substantially used when the control rotational angle θc is calculated by the control angle calculation unit 32. Therefore, in such case, the estimation unit 321 may not be included in the control angle calculation unit 32. In addition, the voltage command values Vdo and Vqo and the current detection values Idd and Iqd may not be input to the control angle calculation unit 32. In such case, the control angle calculation unit 32 calculates the control rotational angle θc of the rotor by using the detection angle deviation Δθd. In such case, it is preferable to set the response frequency (cutoff frequency) from Δθd to θc to a value between three times and five times the frequency of the true speed variation (for example, greater than or equal to 175 Hz). With the aforementioned configuration, it is possible to have the control rotational angle θc follow the true speed variation, and it is possible to have the influence of the noise components included in the current detection values Iud, Ivd, and Iwd be less likely received.

As a result, although the control rotational angle θc is calculated using only the detection angle deviation Δθd, the torque variation can be reduced, and it is possible to have the rotary electric machine 1 become quieter. Further, although the rotary electric machine 1 is a synchronous reluctance motor where the alternating current component (ripple error) of the error of the rotation sensor 2 is suitably reduced, it is possible to maximize the output thereof.

In addition, Kd=0 and Ke=1 may always be set regardless of the velocity proportional physical quantity. When Kd=0 and Ke=1, the control angle calculation unit 32 always calculates the control rotational angle θc by using both the estimated actual angle deviation Δθe and the detection angle deviation Δθd. As in the case of Kd=1 and Ke=0, it is preferable that the response frequency (cutoff frequency) from Δθe to θc is set to a value between three times value to five times value the frequency of the true speed variation (for example, greater than or equal to 175 Hz). With the above configuration, it is possible to have the control rotational angle θc follow the true speed variation, and it is possible to have the influence of the noise components included in the current detection values Iud, Ivd, and Iwd be less likely received. As a result, it is possible to reduce the torque variation, and it is possible to have the rotary electric machine 1 become quieter.

### <For Resistance Value R of Winding Preset and Inductance Values Ld and Lq>

FIG. 12 shows a case where a difference is generated between the electrical constants (the inductance values Ld and Lq) preset in the feedback controller and the actual electrical constants (Ld_real and Lq_real) of the rotary electric machine 1 in the structure of Patent Document 1. Specifically, the horizontal axis of FIG. 12 is a variation ratio (Ld_real/Ld and Lq_real/Lq), and the vertical axis is the direct current component of the detection angle deviation Δθd.

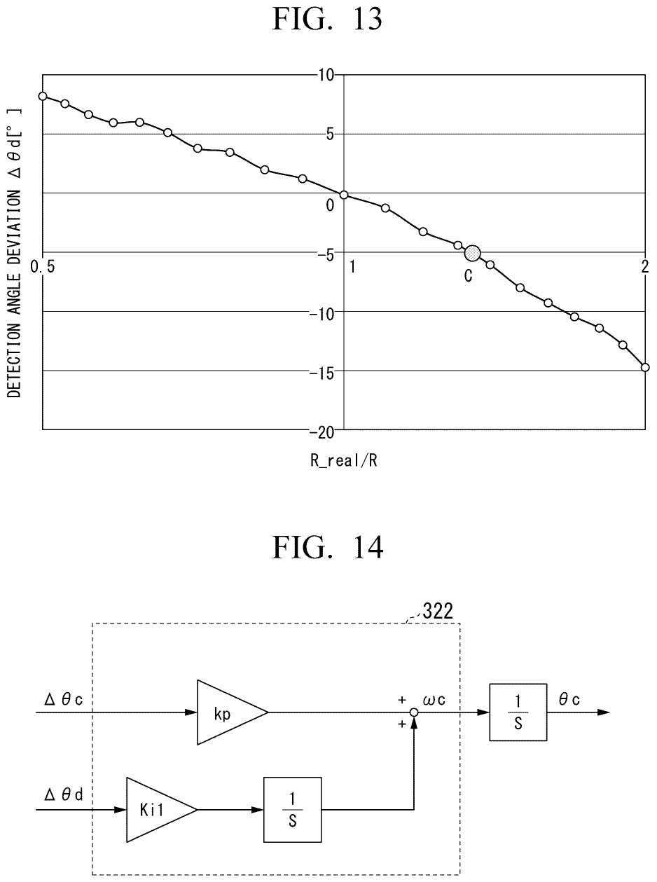

FIG. 13 shows a case where the resistance value R_real of the actual rotary machine varies with respect to the resistance value R of the winding preset in the feedback controller in the structure of Patent Document 1, and a difference is generated between the two. Specifically, the horizontal axis of FIG. 13 is a variation ratio (R_real/R), and the vertical axis is the direct current component of the detection angle deviation Δθd.

In FIGS. 12 and 13, the detection angle deviation Δθd is calculated as in Expression (1-13).

$$\begin{matrix}[ Math 13 ] & \\ Δ θ d = θ c - θ d & ( 1 - 13 )\end{matrix}$$

Here, when the control rotational angle θc has a negative sign, the control rotational angle θc means that the control rotational angle θc is delayed from the rotational angle detection value θd based on the rotation sensor 2. In addition, when the control rotational angle θc has a positive or negative sign, the control rotational angle θc means that the control rotational angle θc is advanced from the rotational angle detection value θd.

As shown in FIG. 12, the nonlinearity of the control increases in a region where the variation ratio (Ld_real/Ld and Lq_real/Lq) is less than 1. Therefore, it is preferable to perform the control in a region where the variation ratio is more than 1 in FIG. 12. It is preferable that the inductance values Ld and Lq in the feedback controller 322 are set to be smaller than the actual inductance values Ld_real and Lq_real.

In FIG. 13, the influence of whether or not the variation ratio (R_real/R) is greater than 1 on the linearity is small as compared with that in FIG. 12. However, when the value of Δθd is output as a positive sign, the current control is less likely to be unstable. Therefore, it is preferable that the resistance value R is set to be smaller than the actual resistance value R_real.

As described above, it is preferable that the inductance values Ld and Lq and the resistance value R of the winding preset in the feedback controller 322 are smaller than the inductance values Ld_real and Lq_real or the resistance value R_real when the rotary electric machine 1 is in a no-load state.

### Second Embodiment

Next, a rotary electric machine according to a second embodiment is explained. Since the basic configuration according to the present embodiment is the same as that of the first embodiment, explanations are made with a focus on points of difference. In the present embodiment, the structure of the feedback controller 322 in the control angle calculation unit 32 is different from that of the first embodiment.

FIG. 14 shows an example configuration of a feedback controller 322 according to the present embodiment. As shown in FIG. 14, the feedback controller 322 includes one adder. The control rotation speed ωc is calculated by the adder. Specifically, the control rotation speed ωc is calculated by adding the “value obtained by multiplying the control angle deviation Δθc by the proportional gain kp” and the “value obtained by multiplying the detection angle deviation Δθd by the integral gain Ki1 and integrating the result once”.

In the above configuration, when the control rotational angle θc is obtained based on the control angle deviation Δθc and the detection angle deviation Δθd, feedback control is performed such that the values of Δθc and Δθd approach 0. In addition, the control rotational angle θc is calculated by integrating the control rotation speed ωc.

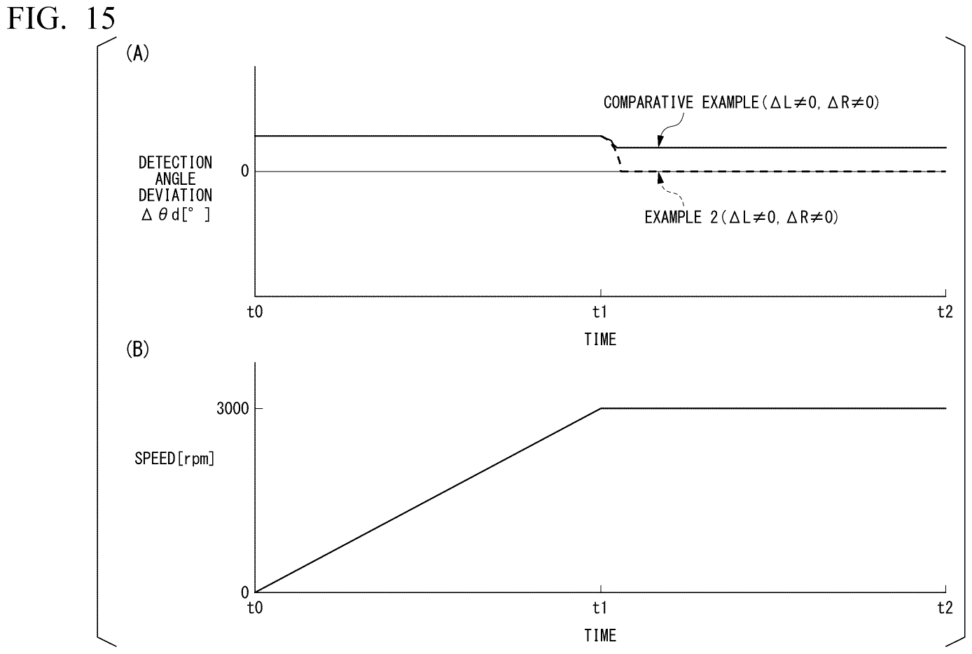

FIGS. 15 (A) and (B) show graphs when the feedback controller according to Comparative Example (configuration described in Patent Document 1) and Example 2 (configuration shown in FIG. 14) is used. In such example, a case where a difference is generated in the d axis and q axis inductance values Ld and Lq preset in the feedback controller with respect to actual d axis and q axis inductance values Ld_real and Lq_real of the rotary electric machine 1 is provided. In addition, a case where a difference is generated in the resistance value R preset in the feedback controller with respect to the actual resistance value R_real of the rotary electric machine 1 is provided. FIG. 15 (A) shows the detection angle deviation Δθd derived under the aforementioned conditions, and FIG. 15 (B) shows the rotation speed at such time.

In FIG. 15 (B), the rotation speed varies from 0 rpm to 3000 rpm between time t0 and t1, and is constant at 3000 rpm between time t1 and t2. Hereinafter, the description is made by classification into “between time t0 and t1 (speed variation section)” and “between time t1 and t2 (constant speed section)”.

As described in the first embodiment, in the method of Comparative Example, problems A and B are generated. In other words, at the constant speed section, whether or not the direct current component of the detection angle deviation Δθd matches 0° is determined depending on whether or not the “electrical constant preset in the feedback controller” matches the “actual electrical constant of the rotary electric machine 1”. In addition, in the speed variation section, the direct current component of the detection angle deviation Δθd does not match 0° regardless of whether or not the “electrical constant preset in the feedback controller” matches the “actual electrical constant of the rotary electric machine”.

Therefore, in the present embodiment, in order to address problem A, the feedback controller 322 is configured as shown in FIG. 14. With such configuration, the feedback control is performed such that the direct current integration of the detection angle deviation Δθd is 0. As a result, when the “electrical constant preset in the feedback controller 322” does not match the “actual electrical constant of the rotary electric machine 1”, it is possible to have the detection angle deviation Δθd in the “between time t1 and t2 (constant speed section)” be approximately 0° as shown in Example 2 of FIG. 15.

Here, in the “between time t0 and t1 (speed variation section)” in FIG. 15, the detection angle deviation Δθd does not match 0° even in the configuration of Example 2, unlike in Example 1 (see FIG. 10). The reason is that the feedback controller 322 of Example 2 does not use the value obtained by performing integration twice in the feedback control. However, even in Example 2, when the speed variation is small, it is possible to suppress an increase in the detection angle deviation Δθd, and it is possible to further reduce the calculation processing load. Therefore, when the rotation speed of the rotary electric machine 1 is low, in other words, when the speed variation is small, it is possible to suitably use the configuration of the present embodiment.

### Third Embodiment

Next, a rotary electric machine control device according to a third embodiment is explained. Since the basic configuration according to the present embodiment is the same as that of the first embodiment, explanations are made with a focus on points of difference. In the present embodiment, the structure of the feedback controller 322 in the control angle calculation unit 32 is different from that of the first embodiment.

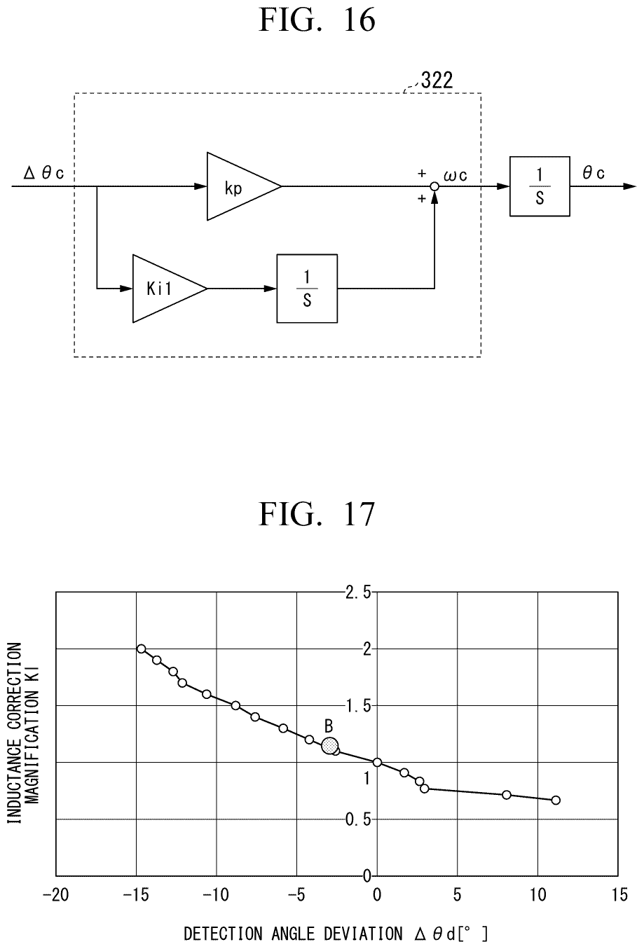

FIG. 16 shows an example configuration of a feedback controller 322 according to the present embodiment. As shown in FIG. 16, the feedback controller 322 includes one adder. The control rotation speed ωc is calculated by the adder. Specifically, the control rotation speed ωc is calculated by adding the “value obtained by multiplying the control angle deviation Δθc by the proportional gain kp” and the “value obtained by multiplying the control angle deviation Δθc by the integral gain Ki1 and integrating the result once”.

In the present embodiment, the q axis inductance value Lq and the d axis inductance value Ld set in the feedback controller 322 are varied to suppress the direct current component of the detection angle deviation Δθd. FIG. 17 shows an example of an inductance correction magnification Kl with respect to the detection angle deviation Δθd when a difference is generated between the preset electrical constants (the inductance values Ld and Lq) and the actual electrical constants (the inductance values Ld_real and Lq_real) of the rotary electric machine 1. Since the inductance correction magnification Kl differs for each rotary electric machine 1, for example, measurements may be performed in advance, and the inductance correction magnification Kl suitable for each individual rotary electric machine 1 may be obtained. In addition, the inductance correction magnification Kl may be obtained for a result of applying a known low-pass filter to the detection angle deviation Δθd.

From FIG. 12, a relationship between the variation ratio of the inductance value (Ld_real/Ld or Lq_real/Lq) and the detection angle deviation Δθd is known. Here, attention is paid to point A in FIG. 12. In the state at point A, Ld_real/Ld or Lq_real/Lq is greater than 1, and the detection angle deviation Δθd is a negative value. When the detection angle deviation Δθd at point A is plotted in FIG. 17, it becomes point B. At B point in FIG. 17, the inductance correction magnification Kl is greater than 1.

Therefore, in the present embodiment, the new inductance values Ld and Lq obtained by multiplying the inductance values Ld and Lq preset in the feedback controller 322 by the correction magnification Kl that is greater than 1 are used. Accordingly, the variation ratio (Ld_real/Ld or Lq_real/Lq) approaches 1, and the detection angle deviation Δθd approaches 0 as shown in FIG. 12. When the aforementioned loop is repeated, the loop acts such that the inductance values Ld and Lq finally match the actual inductance values Ld_real and Lq_real.

As described above, in the present embodiment, the inductance correction magnification Kl corresponding to the detection angle deviation Δθd is obtained, and the correction magnification Kl is multiplied by the preset inductance values Lq and Ld. Accordingly, it is possible to have the actual electrical constants (the inductance values Ld_real and Lq_real) of the rotary electric machine 1 match the electrical constants (inductance values Ld and Lq) set in the feedback controller 322. In addition, by obtaining the estimated actual angle deviation Δθe, it is possible to obtain an effect of suppressing an increase in the direct current component of the detection angle deviation Δθα.

### Fourth Embodiment

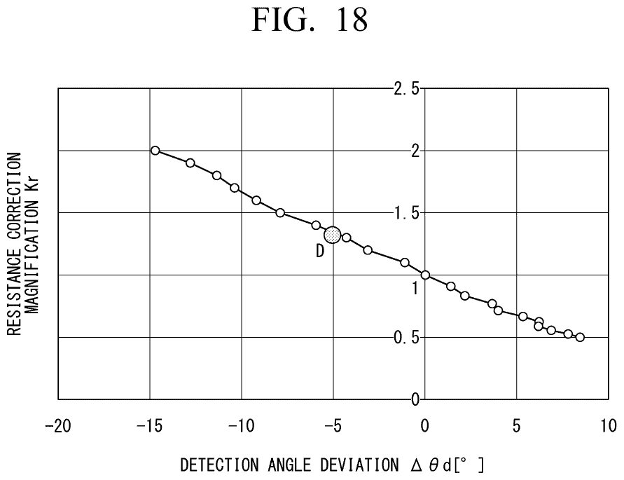

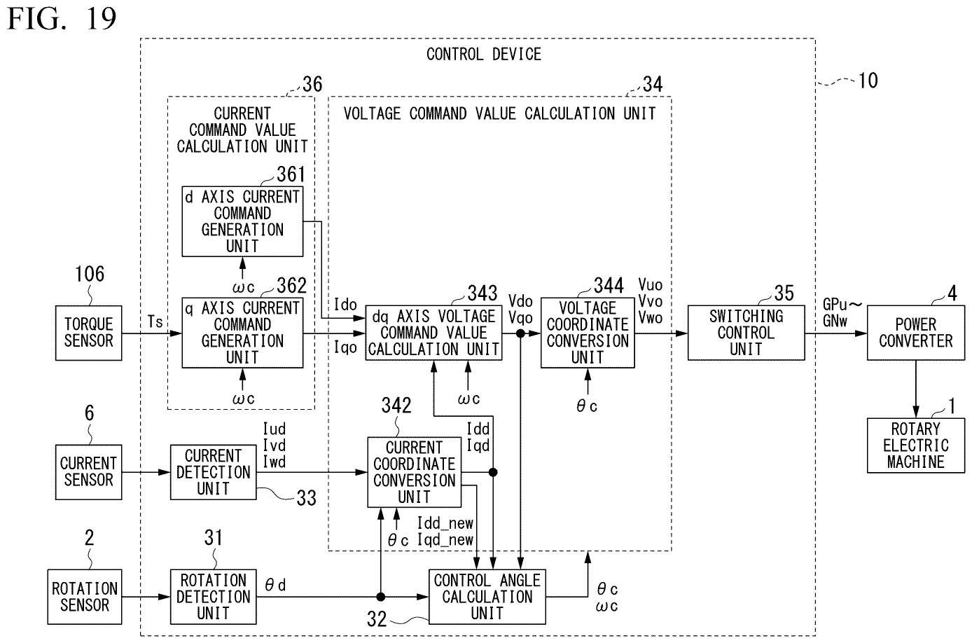

Next, a rotary electric machine control device according to the second embodiment is explained. Since the basic configuration according to the present embodiment is the same as that of the third embodiment, explanations are made with a focus on points of difference. The control angle calculation unit 32 in the present embodiment causes the preset resistance value R of the winding to be varied such that the direct current component of the detection angle deviation Δθd is suppressed. FIG. 18 shows an example of a resistance correction magnification Kr with respect to the detection angle deviation Δθd when a difference is generated between the preset electrical constant (the resistance value R) and the actual electrical constant (the resistance value R_real) of the rotary electric machine 1. Since the resistance correction magnification Kr differs for each rotary electric machine 1, for example, measurements may be performed in advance, and the resistance correction magnification Kr suitable for each individual rotary electric machine 1 may be obtained. In addition, the resistance correction magnification Kr may be obtained for a result of applying a known low-pass filter to the detection angle deviation Δθd.

From FIG. 13, a relationship between the variation ratio of the resistance value (R_real/R) and the detection angle deviation Δθd is known. Here, attention is paid to point C in FIG. 13. In the situation of point C, R_real/R is greater than 1, and the detection angle deviation Δθd is a negative value. When the detection angle deviation Δθd at point C is plotted in FIG. 18, it becomes point D. At point D in FIG. 18, the resistance correction magnification Kr is greater than 1.

Therefore, in the present embodiment, a new resistance value obtained by multiplying the resistance value R preset in the feedback controller 322 by the correction magnification Kr greater than 1 is used. Accordingly, the variation ratio (R_real/R) approaches 1, and the detection angle deviation Δθd approaches 0 as shown in FIG. 13. When the aforementioned loop is repeated, the loop acts such that the resistance value R finally matches the actual resistance value R_real.

As described above, in the present embodiment, the resistance correction magnification Kr corresponding to the detection angle deviation Δθd is obtained, and the resistance correction magnification Kr is multiplied by the preset resistance value R. Accordingly, the actual electrical constant (the resistance value R_real) of the rotary electric machine 1 can be made to match the electrical constant (resistance value R) set in the feedback controller 322. In addition, by obtaining the estimated actual angle deviation Δθe, an effect of suppressing an increase in the direct current component of the detection angle deviation Δθd is obtainable.

In the third and fourth embodiments, the inductance correction magnification Kl or the resistance correction magnification Kr may be obtained under mutually suitable conditions in consideration of the current condition or the rotational speed condition.

### Fifth Embodiment

Next, a rotary electric machine control device according to a fifth embodiment is explained. Since the basic configuration according to the present embodiment is the same as that of the first embodiment, explanations are made with a focus on points of difference. In the present embodiment, the processing in the current coordinate conversion unit 342 and the feedback controller 322 is different from that in the first embodiment. Here, any structure explained in the first to third embodiments may be employed as the structure of the feedback controller 322.

FIG. 19 shows a functional block diagram of the control device 10 according to the present embodiment. As shown in FIG. 19, in the present embodiment, the rotational angle detection value θd is input to the current coordinate conversion unit 342. The current coordinate conversion unit 342 calculates a d axis new current detection value Idd_new and a q axis new current detection value Iqd_new based on Expression (5-1). Specifically, the current coordinate conversion unit 342 performs the three-phase two-phase conversion and the rotational coordinate conversion on the current detection values Iud, Ivd, and Iwd of the three-phase winding based on the rotational angle detection value θd. The current coordinate conversion unit 342 always performs such conversion. Here, the current coordinate conversion unit 342 also calculates the d axis and q axis current detection values Id d and Iqd based on Expression (1-1).

$$\begin{matrix}[ Math 14 ] & \\ [ \begin{matrix}Idd\_new \\ Iqd\_new\end{matrix} ] = \sqrt{\frac{2}{3}} [ \begin{matrix}cos θ d & cos ( θ d - \frac{2 π}{3} ) & cos ( θ d + \frac{2 π}{3} ) \\ - sin θ d & - sin ( θ d - \frac{2 π}{3} ) & - sin ( θ d + \frac{2 π}{3} )\end{matrix} ] [ [ \begin{matrix}Iud \\ I v d \\ I w d\end{matrix} ] & ( 5 - 1 )\end{matrix}$$

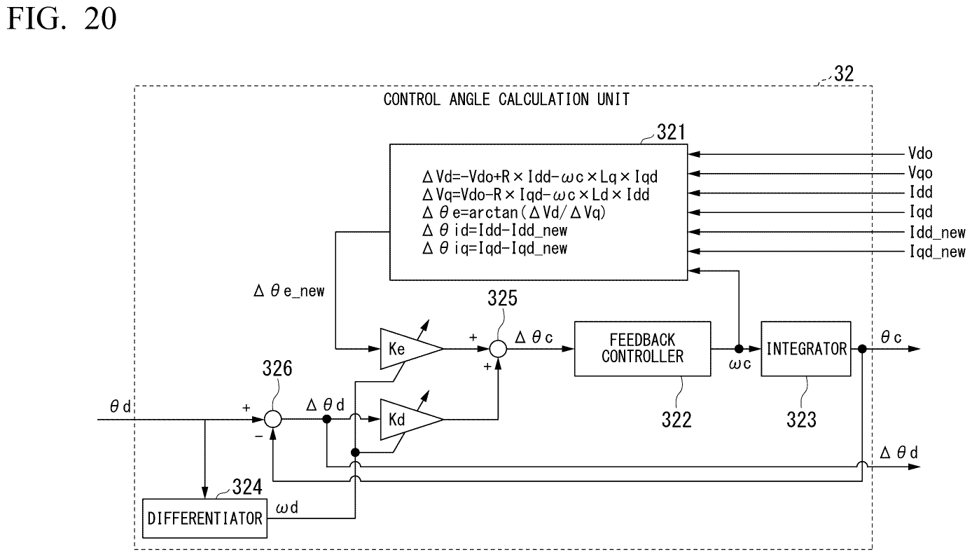

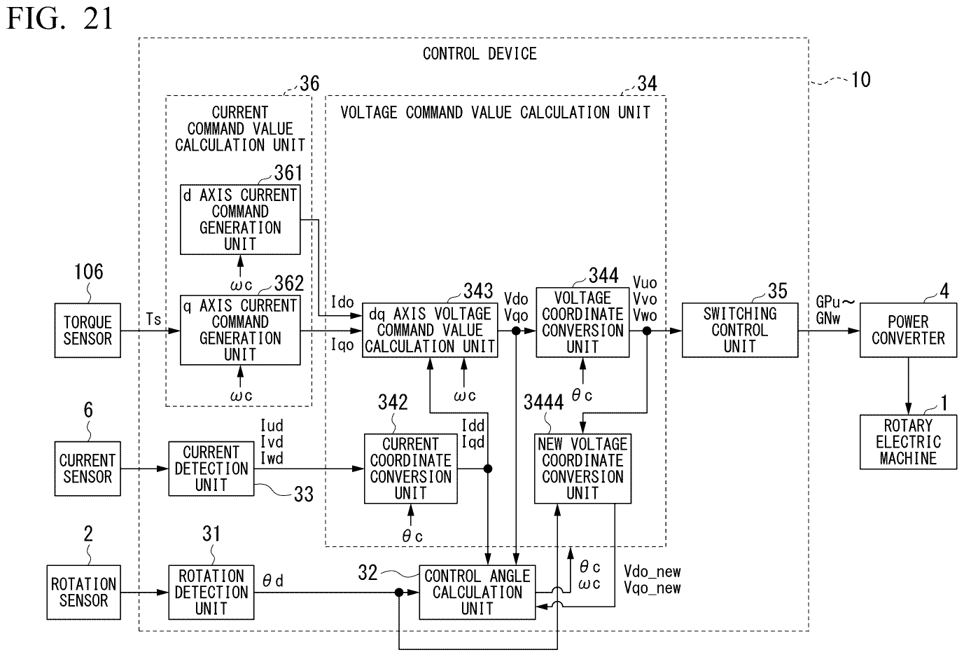

As shown in FIG. 19, the d axis and q axis current detection values Idd and Iqd and the d axis and q axis new current detection values Idd_new and Iqd_new calculated by the current coordinate conversion unit 342 are input to the control angle calculation unit 32. FIG. 20 shows an example configuration of the control angle calculation unit 32 according to the present embodiment. As shown in FIG. 20, the estimation unit 321 of the control angle calculation unit 32 according to the present embodiment calculates a d axis current angle deviation Δθid and a q axis current angle deviation Δθiq based on the d axis and q axis current detection values Idd and Iqd, and the d axis and q axis new current detection values Idd_new and Iqd_new. Specifically, the estimation unit 321 performs the calculation of Expression (5-2). In such case, a known low-pass filter may be applied to the d axis current angle deviation Δθid and the q axis current angle deviation Δθiq that are obtained.

$$\begin{matrix}[ Math 15 ] & \\ Δθ id = Idd - Idd\_new & ( 5 - 2 )\end{matrix}$$

$$Δθ iq = Iqd - Iqd\_new$$

The estimation unit 321 calculates a corrected estimated actual angle deviation Δθe_new by using Expression (5-3) or Expression (5-4). The control angle calculation unit 32 then uses the corrected estimated actual angle deviation Δθe_new instead of the estimated actual angle deviation Δθe used in the first to fourth embodiments.

$$\begin{matrix}[ Math 16 ] & \\ Δ θ e\_new = Δ θ e - Δθ id - Δ θ iq & ( 5 - 3 )\end{matrix}$$

$$\begin{matrix}[ Math 17 ] & \\ Δ θ e\_new = Δθ e - Δθ id & ( 5 - 4 )\end{matrix}$$

In other words, in the present embodiment, the corrected estimated actual angle deviation Δθe_new obtained by correcting the estimated actual angle deviation Δθe is used. In addition, the control rotational angle θc is made to approach the rotational angle detection value θd. As a result, it is possible to suppress an increase in the error of the direct current component included in the estimated actual angle deviation Δθe, which is generated when a difference is generated between the “electrical constant preset in the feedback controller 322” and the “actual electrical constant of the rotary electric machine 1”.

### Sixth Embodiment

Next, a rotary electric machine control device according to the second embodiment is explained. Since the basic configuration according to the present embodiment is the same as that of the first embodiment, explanations are made with a focus on points of difference. As shown in FIG. 21, the voltage command value calculation unit 34 according to the present embodiment includes a new voltage coordinate conversion unit 3444. As the structure of the feedback controller 322, any of the structures explained in the first to third embodiments may be employed.

As shown in FIG. 21, the rotational angle detection value θd and the voltage command values Vuo, Vvo, and Vwo of the three phases are input to the new voltage coordinate conversion unit 3444. As shown in Expression (6-1), the new voltage coordinate conversion unit 3444 performs calculation of d axis and q axis new voltage command values Vdo_new and Vqo_new. Specifically, the three-phase two-phase conversion and the rotational coordinate conversion are performed on the voltage command values Vuo, Vvo, and Vwo based on the rotational angle detection value θd. The new voltage coordinate conversion unit 3444 always performs the aforementioned conversion.

$$\begin{matrix}[ Math 18 ] & \\ [ \begin{matrix}Vdo\_new \\ Vqo\_new\end{matrix} ] = \sqrt{\frac{2}{3}} [ \begin{matrix}cos θ d & cos ( θ d - \frac{2 π}{3} ) & cos ( θ d + \frac{2 π}{3} ) \\ - sin θ d & - sin ( θ d - \frac{2 π}{3} ) & - sin ( θ d + \frac{2 π}{3} )\end{matrix} ] [ \begin{matrix}Vuo \\ Vvo \\ Vwo\end{matrix} ] & ( 6 - 1 )\end{matrix}$$

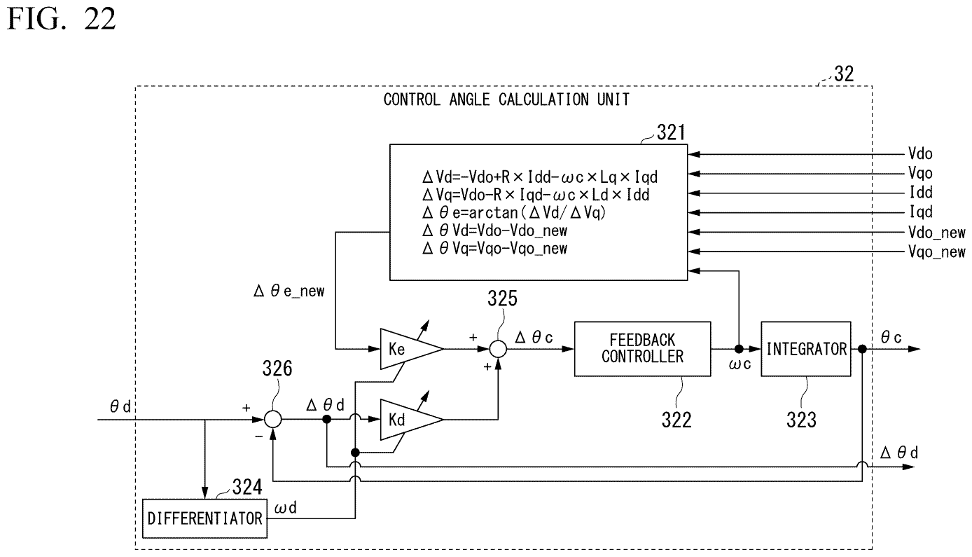

FIG. 22 shows a block diagram of the control angle calculation unit 32 according to the present embodiment. As shown in FIG. 22, the new voltage command values Vdo_new and Vqo_new are input to the estimation unit 321 according to the present embodiment. The estimation unit 321 obtains a d axis voltage angle deviation ΔθVd and a q axis voltage angle deviation ΔθVq using Expression (6-2). In such case, a known low-pass filter may be applied to the d axis voltage angle deviation ΔθVd and the q axis voltage angle deviation ΔθVq that are obtained.

$$\begin{matrix}[ Math 19 ] & \\ Δθ Vd = Vdo - Vdo\_new & ( 6 - 2 )\end{matrix}$$

$$Δθ Vq = Vqo - Vqo\_new$$

Further, the estimation unit 321 calculates the corrected estimated actual angle deviation Δθe_new by Expression (6-3) or Expression (6-4). Then, the control angle calculation unit 32 uses the corrected estimated actual angle deviation Δθe_new instead of the estimated actual angle deviation Δθe used in the first to fourth embodiments.

$$\begin{matrix}[ Math 20 ] & \\ Δ θ e\_new = Δ θ e - Δθ Vd - Δ θ Vq & ( 6 - 3 )\end{matrix}$$

$$\begin{matrix}[ Math 21 ] & \\ Δ θ e\_new = Δθ e - Δθ Vd & ( 6 - 4 )\end{matrix}$$

In other words, in the present embodiment, the corrected estimated actual angle deviation Δθe_new obtained by correcting the estimated actual angle deviation Δθe is used. In addition, the control rotational angle θc is made to approach the rotational angle detection value θd. As a result, it is possible to suppress an increase in the error of the direct current component included in the estimated actual angle deviation Δθe, which is generated when a difference is generated between the “electrical constant preset in the feedback controller 322” and the “actual electrical constant of the rotary electric machine 1”.

Although various exemplary embodiments and examples are described in the present application, various features, aspects, and functions described in one or a plurality of embodiments are not limited to the application of a specific embodiment, and may be applied to the embodiment alone or in various combinations. Accordingly, innumerable modification examples that are not shown are assumed to be within the technical scope disclosed in the specification of the present application. For example, a case where at least one component is modified, added, or omitted, and a case where at least one component is extracted and combined with components of other embodiments is included. As a specific example, the feedback controller 322 explained in the first embodiment or the second embodiment may execute the control explained in the third embodiment.

In the above description, the rotary electric machine control device 10, the electric power steering device 100, and the vehicle according to the present disclosure are explained. The present disclosure is summarized as follows.

The control device 10 controls the rotary electric machine 1 having a stator in which the windings Cu, Cv, and Cw of a plurality of phases are provided and a rotor in which a magnet is provided, via the power converter 4. The control device 10 includes the rotation detection unit 31 that detects the rotational angle (the rotational angle detection value θd) of the rotor based on the output signal of the rotation sensor 2, the control angle calculation unit 32 that calculates the control rotational angle θc of the rotor, the current detection unit 33 that detects the current flowing through the windings Cu, Cv, and Cw of a plurality of phases based on the output signal of the current sensor 6, the voltage command value calculation unit 34 that calculates the voltage command values Vuo, Vvo, and Vwo to be applied to the windings Cu, Cv, and Cw of a plurality of phases based on the control rotational angle θc and the current detection values Iud, Ivd, and Iwd, and the switching control unit 35 that switches on and off a plurality of switching elements SP and SN included in the power converter 4 based on the voltage command values Vuo, Vvo, and Vwo.

The control angle calculation unit 32 calculates an estimated actual angle deviation Δθe that is a deviation of the control rotational angle θc with respect to the true rotational angle of the rotor, based on the information on the current detection value, the information on the voltage command value, and the electrical constants (the inductance values Ld and Lq or the resistance value R) of the rotary electric machine 1, calculates the detection angle deviation Δθd that is a deviation of the control rotational angle θc with respect to the rotational angle detection value θd, calculates a value obtained by internally dividing the estimated actual angle deviation Δθe and the detection angle deviation Δθd as the control angle deviation Δθc, calculates the control rotation speed ωc based on the control angle deviation Δθc, and calculates the control rotational angle θc by integrating the control rotation speed ωc.

Then, the control angle calculation unit 32 uses a value obtained by integrating the detection angle deviation Δθd when the control rotation speed ωc is calculated (see FIGS. 8, 14, and 16). Alternatively, the control angle calculation unit 32 corrects the estimated actual angle deviation Δθe based on the rotational angle detection value θd (see Expressions 5-1 to 5-4 and Expressions 6-1 to 6-4).

With the control device 10, it is possible to reduce the direct current component of the sensor angle error.

Here, the “information on the current detection value” may be the current detection values Iud, Ivd, and Iwd of the three phases output by the current detection unit 33, may be the two axes (the d axis and the q axis) current detection values Idd and Iqd output by the current coordinate conversion unit 342, or may be values obtained by processing these detection values. Similarly, the “information on the voltage command value” may be the voltage command values Vdo and Vqo of the two axes (the d axis and the q axis) output by the dq axis voltage command value calculation unit 343, may be the voltage command values Vuo, Vvo, and Vwo of the three phases output by the voltage coordinate conversion unit 344, or may be values obtained by processing these command values.

In addition, the electric power steering device 100 according to the present embodiment includes the control device 10 and the rotary electric machine 1. The vehicle according to the present embodiment includes the electric power steering device 100. With the electric power steering device 100 or the vehicle, it is possible to solve the problem of the torque (output) which is outputted being different depending on the rotation direction of the rotary electric machine 1. Therefore, it is possible to suppress a difference in torque output by the rotary electric machine 1 between a case where the driver steers the steering wheel 104 in the left direction and a case of steering in the right direction. As a result, it is possible to suppress a difference in steering feel felt by the driver due to a difference in the rotation direction of the steering wheel 104.

Reference Signs List

1 . . . Rotary electric machine, 2 . . . Rotation sensor, 4 . . . Power converter,
6 . . . Current sensor, 10 . . . Control device, 31 . . . Rotation determination unit,
32 . . . Control angle calculation unit, 33 . . . Current determination unit,
34 . . . Voltage command value calculation unit, 35 . . . Switching control unit,
100 . . . Electric power steering device, SPu~SNw . . . Switching element,
Th . . . Velocity threshold value, Δ θ c . . . Control angle deviation,
Δ θ d . . . Determination angle deviation, Δ θ e . . . Estimated actual angle deviation,
θ c . . . Control rotational angle, θ d . . . Rotational angle determination value,
ω . . . Rotational angular velocity, ωc . . . Control rotation speed

1. A rotary electric machine control device configured to control a rotary electric machine including a stator provided with windings of a plurality of phases and a rotor provided with a magnet, via a power converter, the rotary electric machine control device comprising:
a rotation detection unit that detects a rotational angle of the rotor based on an output signal of a rotation sensor;
a control angle calculation unit that calculates a control rotational angle of the rotor;
a current detection unit that detects a current flowing through the windings of the plurality of phases based on an output signal of a current sensor;
a voltage command value calculation unit that calculates a voltage command value to be applied to the windings of the plurality of phases based on the control rotational angle and a current detection value; and
a switching control unit that switches ON and OFF a plurality of switching elements included in the power converter based on the voltage command value, wherein
the control angle calculation unit
calculates an estimated actual angle deviation that is a deviation of the control rotational angle with respect to a true rotational angle of the rotor, based on information on the current detection value, information on the voltage command value, and an electrical constant of the rotary electric machine,
calculates a detection angle deviation that is a deviation of the control rotational angle with respect to a rotational angle detection value,
calculates a value obtained by internally dividing the estimated actual angle deviation and the detection angle deviation as a control angle deviation,
calculates a control rotation speed based on the control angle deviation,
calculate the control rotational angle by integrating the control rotation speed, and
uses a value obtained by integrating the detection angle deviation when the control rotation speed is calculated, or correct the estimated actual angle deviation based on the rotational angle detection value.

2. The rotary electric machine control device according to claim 1, wherein
the control angle calculation unit is configured to calculate the control rotation speed by using a value obtained by integrating the detection angle deviation twice.

3. The rotary electric machine control device according to claim 1, wherein
the control angle calculation unit
increases a ratio of the estimated actual angle deviation relative to a ratio of the detection angle deviation in the control angle deviation when a velocity proportional physical quantity, which is a physical quantity proportional to a rotational angular velocity of the rotor, is higher than a preset velocity threshold value, and
decreases the ratio of the estimated actual angle deviation relative to the ratio of the detection angle deviation in the control angle deviation when the velocity proportional physical quantity is lower than the velocity threshold value.

4. The rotary electric machine control device according to claim 1, wherein
the control angle calculation unit
continuously increases a ratio of the estimated actual angle deviation from 0 to 1 and continuously decreases a ratio of the detection angle deviation from 1 to 0 as a velocity proportional physical quantity increases, when the velocity proportional physical quantity, which is a physical quantity proportional to a rotational angular velocity of the rotor, is within a preset range,
sets the ratio of the estimated actual angle deviation to 0 and sets the ratio of the detection angle deviation to 1 when the velocity proportional physical quantity is lower than the range, and
sets the ratio of the estimated actual angle deviation to 1 and sets the ratio of the detection angle deviation to 0 when the velocity proportional physical quantity is higher than the range.

5. The rotary electric machine control device according to claim 1, wherein
an inductance value of the rotary electric machine is used as the electrical constant used for calculating the estimated actual angle deviation, and the inductance value is set to a value smaller than an inductance value of the rotary electric machine in a no-load state.

6. The rotary electric machine control device according to claim 1, wherein
a resistance value of the rotary electric machine is used as the electrical constant used for calculating the estimated actual angle deviation, and the resistance value is set to a value smaller than a resistance value of the rotary electric machine in a no-load state.

7. An electric power steering device comprising:
the control device according to claim 1; and
the rotary electric machine controlled by the control device.

8. A vehicle comprising:
the electric power steering device according to claim 7.
